(19) United States
(12) Patent Application Publication
(10) Pub. No.: US 2026/0253053 A1
(43) Pub. Date: Aug. 27, 2026

(54) LOTTERY TICKET DATA INTERCEPTOR FOR A POINT-OF-SALE SYSTEM

(71) Applicant: Brightstar Global Solutions Corporation, Providence, RI (US)

(72) Inventors: Michael Roeygaard, Rome (IT); Apostolos D. Kallis, Barrington, RI (US); Henry Constant, West Warwick, RI (US); Robert Corvese, Warwick, RI (US)

(21) Appl. No.: 19/642,041

(22) Filed: Apr. 8, 2026

Related U.S. Application Data
(63) Continuation-in-part of application No. 19/370,282, filed on Oct. 27, 2025.
Application No. 19/370,282 is a continuation of application No. 17/930,601, filed on Sep. 8, 2022, now Pat. No. 12,462,236.

(51) Int. Cl. G06Q 20/20; G07F 17/32; G07G 1/00

(52) U.S. Cl. CPC G06Q 20/20; G07F 17/329; G07G 1/0045

(57) ABSTRACT

A POS lottery ticket data interceptor for a point-of-sale system, and systems and methods employing such POS lottery ticket data interceptor with POS systems that enable the activation, purchase, validation, and/or redemption of lottery tickets having variable purchase prices and/or variable payout amounts for winning lottery tickets through such POS systems.

### PRIORITY

This application is a continuation-in-part of, claims priority to and the benefit of U.S. patent application Ser. No. 19/370,282, filed on Oct. 27, 2025, which application is a continuation of, claims priority to and the benefit of U.S. patent application Ser. No. 17/930,601, filed on Sep. 8, 2022, now U.S. Pat. No. 12,462,236, issued on Nov. 4, 2025, the entire contents of both of which is incorporated herein by reference.

### BACKGROUND

The present disclosure relates to a lottery ticket data interceptor for a point-of-sale (“POS”) system that enables purchase and/or redemption of lottery tickets through the POS system.

Lottery tickets such as instant lottery tickets have substantial variations in the structures, configurations, and arrangements of the individual components of inventory control numbers and barcodes for such lottery tickets. These variations occur on a jurisdictional basis and on a manufacturer basis. Lottery tickets such as instant lottery tickets and draw lottery tickets also have substantial variations in their purchase prices and payout amounts for winning lottery tickets. This wide variety of the purchase prices, payout amounts for winning lottery tickets, and of the structures, configurations, and arrangements of the individual components of the inventory control numbers and barcodes for lottery tickets limits the types of systems that can be used to activate, sell, validate, and/or redeem such lottery tickets. For example, POS systems commercially employed by wholesalers and retailers are not configured to activate, sell, validate, or redeem lottery tickets.

### BRIEF SUMMARY

In various embodiments, the present disclosure relates to a point-of-sale (POS) data interceptor communicatively and operably connectable to a POS system comprising a POS system scanner that comprises a POS scanner housing and a POS system terminal that comprises a POS terminal housing. The POS data interceptor comprises: an interceptor housing that is separate from the POS scanner housing and the POS terminal housing; a POS scanner connector supported by the interceptor housing and communicatively connectable to the POS system scanner such that the POS data interceptor is connected to the POS system scanner in place of the POS system terminal; a terminal connector supported by the interceptor housing and communicatively connectable to the POS system terminal such that the POS data interceptor is connected to the POS system terminal in place of the POS system scanner; a data transmitter supported by the interceptor housing; a data receiver supported by the interceptor housing; a processor supported by the interceptor housing and communicatively connected to the POS scanner connector, the terminal connector, the data transmitter, and the data receiver; and a memory device supported by the interceptor housing. The memory device stores a plurality of instructions that when executed by the processor, cause the POS data interceptor to: monitor all scan data received from the POS system scanner based on all scans by the POS system scanner; responsive to receiving scan data that comprises lottery ticket related data that is related to a purchase of a lottery ticket: generate and send a lottery ticket purchase request for the purchase of the lottery ticket based on the lottery ticket related data to a lottery central system, receive from the lottery central system a lottery ticket purchase response comprising a product identifier for the lottery ticket based on the lottery ticket purchase request, and determine and cause transmittal of a product code for the purchase of the lottery ticket to the POS system terminal based on the product identifier; and responsive to receiving scan data from the POS system scanner that does not comprise any lottery ticket related data, cause transmittal of said scan data without modification to the POS system terminal.

In various other embodiments, the present disclosure relates to a point-of-sale (POS) data interceptor communicatively and operably connectable to a POS system comprising a POS system scanner that comprises a POS scanner housing and a POS system terminal that comprises a POS terminal housing. The POS data interceptor comprises: an interceptor housing that is separate from the POS scanner housing and the POS terminal housing; an interceptor scanner connector supported by the interceptor housing and communicatively connectable to an interceptor scanner comprising an interceptor scanner housing that is separate from the POS scanner housing; a terminal connector supported by the interceptor housing and communicatively connectable to the POS system terminal such that the POS data interceptor is connected to the POS system terminal in addition to the POS system scanner; a data transmitter supported by the interceptor housing; a data receiver supported by the interceptor housing; a processor supported by the interceptor housing and communicatively connected to the interceptor scanner connector, the terminal connector, the data transmitter, and the data receiver; and a memory device supported by the interceptor housing. The memory device stores a plurality of instructions that when executed by the processor, cause the POS data interceptor to: monitor all scan data received from the interceptor scanner based on all scans by the interceptor scanner; responsive to receiving scan data that comprises lottery ticket related data that is related to a purchase of a lottery ticket: generate and send a lottery ticket purchase request for the purchase of the lottery ticket based on the lottery ticket related data to a lottery central system, receive from the lottery central system a lottery ticket purchase response comprising a product identifier for the lottery ticket and a value identifier for the lottery ticket that are based on the lottery ticket purchase request, and determine and cause transmittal of a product code for the purchase of the lottery ticket to the POS system terminal based on the product identifier; and responsive to receiving scan data from the interceptor scanner that does not comprise any lottery ticket related data, reject said scan data.

In various other embodiments, the present disclosure relates to a point-of-sale (POS) data interceptor communicatively and operably connectable to a POS system comprising a POS system scanner that comprises a POS scanner housing and a POS system terminal that comprises a POS terminal housing. The POS data interceptor comprises: an interceptor housing that is separate from the POS scanner housing and the POS terminal housing; a POS scanner connector supported by the interceptor housing and communicatively connectable to the POS system scanner such that the POS data interceptor is connected to the POS system scanner in place of the POS system terminal; a terminal connector supported by the interceptor housing and communicatively connectable to the POS system terminal such that the POS data interceptor is connected to the POS system terminal in place of the POS system scanner; a data transmitter supported by the interceptor housing; a data receiver supported by the interceptor housing; a processor supported by the interceptor housing and communicatively connected to the POS scanner connector, the terminal connector, the data transmitter, and the data receiver; and a memory device supported by the interceptor housing. The memory device stores a plurality of instructions that when executed by the processor, cause the POS data interceptor to: monitor all scan data received from the POS system scanner based on all scans by the POS system scanner; responsive to receiving scan data that comprises lottery ticket related data that is related to a redemption of a lottery ticket: generate and send a lottery ticket validation request for the redemption of the lottery ticket based on the lottery ticket related data to a lottery central system, receive from the lottery central system a lottery ticket validation response comprising a product identifier for the lottery ticket and a value identifier for the lottery ticket that are based on the lottery ticket validation request, and determine and cause transmittal of a product code for the redemption of the lottery ticket to the POS system terminal based on the product identifier; and responsive to receiving scan data from the POS system scanner that does not comprise any lottery ticket related data, cause transmittal of said scan data without modification to the POS system terminal.

In various other embodiments, the present disclosure relates to a point-of-sale (POS) data interceptor communicatively and operably connectable to a POS system comprising a POS system scanner that comprises a POS scanner housing and a POS system terminal that comprises a POS terminal housing. The POS data interceptor comprises: an interceptor housing that is separate from the POS scanner housing and the POS terminal housing; an interceptor scanner connector supported by the interceptor housing and communicatively connectable to an interceptor scanner comprising an interceptor scanner housing that is separate from the POS scanner housing; a terminal connector supported by the interceptor housing and communicatively connectable to the POS system terminal such that the POS data interceptor is connected to the POS system terminal in addition to the POS system scanner; a data transmitter supported by the interceptor housing; a data receiver supported by the interceptor housing; a processor supported by the interceptor housing and communicatively connected to the interceptor scanner connector, the terminal connector, the data transmitter, and the data receiver; and a memory device supported by the interceptor housing. The memory device stores a plurality of instructions that when executed by the processor, cause the POS data interceptor to: monitor all scan data received from the interceptor scanner based on all scans by the interceptor scanner; responsive to receiving scan data that comprises lottery ticket related data that is related to a redemption of a lottery ticket: generate and send a lottery ticket validation request for the redemption of the lottery ticket based on the lottery ticket related data to a lottery central system, receive from the lottery central system a lottery ticket validation response comprising a product identifier for the lottery ticket and a value identifier for the lottery ticket that are based on the lottery ticket validation request, and determine and cause transmittal of a product code for the redemption of the lottery ticket to the POS system terminal based on the product identifier; and responsive to receiving scan data from the interceptor scanner that does not comprise any lottery ticket related data, reject said scan data.

Additional features are described in, and will be apparent from, the following Detailed Description and the figures.

### BRIEF DESCRIPTION OF THE SEVERAL VIEWS OF THE DRAWINGS

FIG. 1 is a diagrammatic view of a POS lottery ticket data interceptor of one example embodiment of the present disclosure.

FIG. 2 is a diagrammatic view of a system and method employing a POS lottery ticket data interceptor for a POS system in accordance with a first example embodiment of the present disclosure.

FIG. 3 is a diagrammatic view of a system and method employing a POS lottery ticket data interceptor for a POS system in accordance with a second example embodiment of the present disclosure.

FIG. 4 is a diagrammatic view of a system and method employing a POS lottery ticket data interceptor for a POS system in accordance with a third example embodiment of the present disclosure.

FIG. 5 is a diagrammatic view of a system and method employing a POS lottery ticket data interceptor for a POS system in accordance with a fourth example embodiment of the present disclosure.

FIG. 6 is a diagrammatic view of a system and method employing a POS lottery ticket data interceptor for a POS system in accordance with a fifth example embodiment of the present disclosure.

FIG. 7 is a diagrammatic view of a system and method employing a POS lottery ticket data interceptor for a POS system in accordance with a sixth example embodiment of the present disclosure.

FIG. 8 is a diagrammatic view of a system and method employing a POS lottery ticket data interceptor for a POS system in accordance with a seventh example embodiment of the present disclosure.

FIG. 9 is a diagrammatic view of a system and method employing a POS lottery ticket data interceptor for a POS system in accordance with an eighth example embodiment of the present disclosure.

### DETAILED DESCRIPTION

In various embodiments, the present disclosure relates generally to a POS lottery ticket data interceptor for a point-of-sale system (referred to herein as a POS system), and systems and methods employing such POS lottery ticket data interceptors with POS systems that enable the activation, purchase, validation, and/or redemption of lottery tickets having variable purchase prices and/or variable payout amounts for winning lottery tickets through such POS systems.

Instant lottery tickets and draw lottery tickets are employed as example lottery tickets herein; however, it should be appreciated that the present disclosure is not meant to be limited by such examples.

### Instant Lottery Tickets

For a better understanding of the present disclosure, example instant lottery tickets are first described herein.

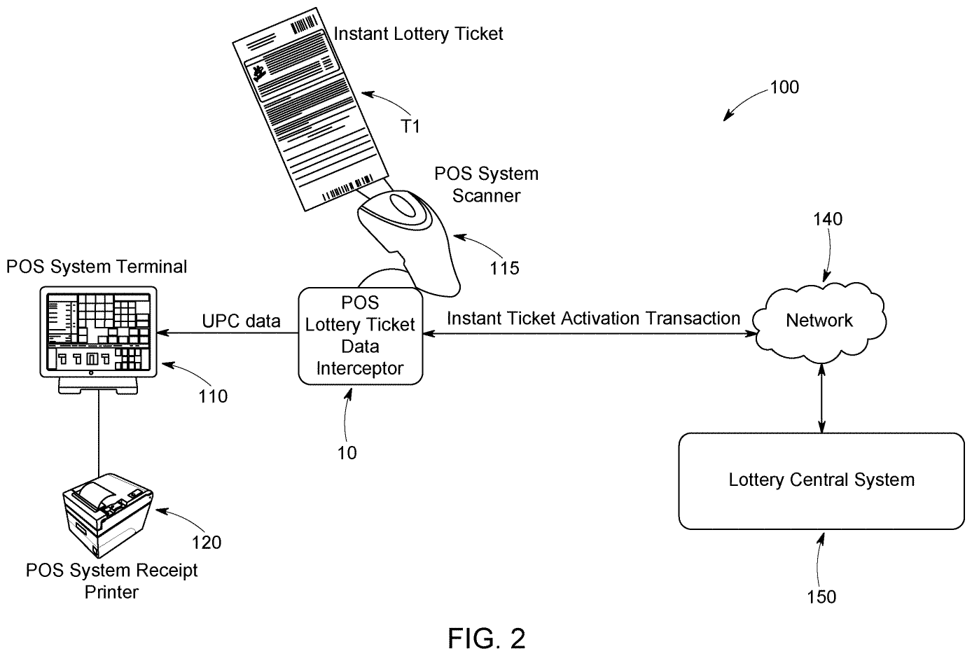

Various known instant lottery tickets are single game instant lottery tickets. Example single game instant lottery ticket such as ticket T1 in FIG. 2 includes: (1) a ticket substrate (not labeled); (2) a front surface (not shown) of the ticket substrate; (3) a predefined scratch-off area (not shown) defined on the front surface; (4) a scratch-off coating (“SOC”) (not shown) covering variable lottery game indicia (not shown) printed on the predefined scratch-off area; (6) a back surface (not labeled) of the ticket substrate; and (7) variable instant lottery ticket information indicia (not labeled) printed on the back surface. The instant lottery ticket information indicia can include text, one or more ticket numbers, one or more ticket barcodes, and other instant lottery ticket information that is either or both human readable and machine readable. Certain of the instant lottery ticket information identifies the instant lottery ticket, the set, run, and/or pack of the instant lottery tickets that this instant lottery ticket is/was part of, and can provide other inventory control information. Various known instant lottery tickets include multiple predefined scratch-off areas, multiple sets of variable lottery game indicia printed on the predefined scratch-off areas, and multiple SOCs covering the variable lottery game indicia sets.

Known instant lottery tickets include a variable human readable inventory control number, associated machine-readable barcode, and legal text printed on the instant lottery ticket back. The inventory control number can include: (1) a three-digit game identifying number; (2) a six-digit pack number; (3) a one-digit check number; and (4) a three-digit ticket number, that together uniquely identify this instant lottery ticket from a pack of instant lottery tickets. The instant ticket's barcode can also represent corresponding identical data. All of this data in both machine and human readable formats specifically only provide limited information regarding the instant lottery ticket. The instant ticket inventory control data on the back of the instant lottery ticket are readable prior to purchase of the instant lottery ticket. This readability enables lottery system warehouse storage, picking, shipping, pack activation, purchase, and redemption of such instant lottery ticket. For security reasons, many lotteries have removed win or loss related information from this visible barcode and placed such information under scratch-off material.

The instant lottery ticket's barcode can be scanned by barcode reading devices but unless those devices are connected to a lottery's instant lottery ticket management system, the devices such as those connected to POS systems cannot process and use the information to enable purchase and/or redemption of such instant lottery tickets. This is in part due to the varying lengths of the inventory, validation, and check digit information, such information being non-uniform and varying from jurisdiction to jurisdiction, which collectively make it very difficult for POS systems to determine how to process and use this data. Additionally, certain lottery tickets have two separate barcodes that are geographically separated on the substrate of the ticket, and which have different barcode formats and encode different data.

Instant lottery tickets are often arranged during manufacture (which includes after complete printing) in instant lottery ticket packs of a static quantity that often varies by price point for storage, for organization, for sorting, for picking, and for shipping to instant lottery ticket sellers (such as instant lottery ticket retailers). The instant lottery ticket packs often include: (1) a stack of instant lottery tickets (that are all of the same type, same size, and same game(s)); and (2) a transparent secure outer wrapping (such as transparent plastic wrapping) around the stack of instant lottery tickets. Such instant lottery ticket packs are often configured such that the back surface of at least one instant lottery ticket is visible through the transparent pack wrapping. Logistical tracking and activation of such instant lottery tickets are accomplished by the grouping of tickets in these packs. There are several reasons for arranging instant lottery tickets in packs. One reason is that instant lottery tickets can be ordered and shipped in packs with the pack being the fundamental unit of reconciliation. Since instant lottery tickets are shipped in packs, the pack is also the fundamental unit of activation on the overall instant lottery ticket system. In other words, individual instant lottery ticket activation is currently done on the pack level instead of the individual ticket level. When a retailer receives a new pack of instant lottery tickets, the retailer must first activate the pack on the instant lottery ticket system before selling any of the instant lottery tickets in that pack. Pack activation thereby enables instant lottery tickets to be shipped via common carrier since un-activated or stolen instant lottery ticket packs can be flagged on the instant lottery ticket system with any instant lottery ticket in that pack designated as invalid if redemption of that instant lottery ticket is attempted.

All of the packs for a given lottery game are logged in a digital ship file by the instant lottery ticket manufacturer and loaded on the instant lottery ticket system prior to the tickets for that lottery game being placed on sale for purchase. The ship file contains a listing of all the manufactured packs identifying (typically by omission) any pack numbers that were destroyed in the manufacturing process. The inventory file for a game is transferred from the ticket manufacturer and loaded into a lottery's instant ticket management system. As a lottery game is placed on sale for purchase, the instant ticket system collects information such as: “pack ‘X’ shipped to retailer ‘Y’”, and then “pack ‘X’ was activated”, or “pack ‘X’ was reported as stolen/missing”, etc. Thus, the ship file enables logistical tracking of all manufactured packs for an instant lottery ticket game. The ship file does not contain any win or lose information and cannot be linked to a validation file.

The validation file contains the validation codes for all instant lottery tickets for a lottery game. The validation codes provide pointers to the prize values (if any) of the instant lottery tickets on the instant lottery ticket system. The validation codes are inaccessible on un-played instant lottery tickets due to a portion of the code being covered by SOC. In some versions, the validation code is also embodied as a barcode hidden under the SOC such that it cannot be scanned until the instant lottery ticket is scratched to expose the barcode, and in other versions there is some validation file information in addition to the inventory control information in the ticket back barcode in an encrypted format. Therefore, the security of the system is partly derived from the validation file being unassociated with the ship file as well as the physical un-played ticket's inventory control information. Both the ship and validation files are generated by the ticket manufacturer before the tickets are shipped to a lottery. Lottery logistical and validation systems require the ship and validation files to be loaded on the lottery system prior to instant tickets being shipped to retailers and placed on sale for purchase. Once loaded onto the system, the basic validation file typically cannot be altered (other than flagged additions—e.g., redeemed, stolen, etc.) thereby ensuring the integrity of the instant ticket game and its predetermined payout.

### Draw Lottery Tickets

For a better understanding of the present disclosure, an example draw lottery ticket is now described herein.

A draw lottery ticket can include: (1) a single set of player numbers for a single play of a draw lottery game; (2) multiple sets of player numbers for a single play of a draw lottery game; (3) a single set of player numbers for each of multiple plays of a draw lottery game; or (4) multiple sets of player numbers for each of multiple plays of a draw lottery game. For simplicity, the present disclosure uses a draw lottery ticket with a single set of player numbers for a single play of a draw lottery game as an example, but it should be appreciated that the present disclosure can be employed for purchasing and redeeming such various other draw lottery tickets.

An example draw lottery ticket includes lottery ticket related information, including a ticket identifier that uniquely identifies the draw lottery ticket, a game identifier that identifies the lottery game type, a draw date associated with the ticket, and a player's selected numbers for a selected play of a selected draw lottery game. It should be appreciated that while this example draw lottery ticket is for a single play, draw lottery tickets often include multiple sets of player numbers that are for a single play of the draw lottery game. The lottery ticket related information can include text, one or more ticket numbers (e.g., the ticket identifier), one or more ticket barcodes, and other lottery ticket information that is in either or both human readable and machine-readable forms. The lottery ticket's barcode is configured to be scanned by a barcode reading device to enable redemption of such draw lottery ticket.

Additionally, for a better understanding of the present disclosure, an example known system and method employed for purchasing draw lottery tickets is also now described. A lottery terminal receives bet slip data (e.g., bet details) that is based on user inputs from a customer for a purchase of a draw lottery ticket. The bet slip data indicates the customer's selected numbers, the selected play of the selected draw lottery game, and/or other suitable lottery ticket information. The lottery terminal generates a wager request based on the bet slip data and sends the wager request to a lottery central system to cause the purchase of the draw lottery ticket. Responsive to the wager request, the lottery central system sends a wager response to the lottery terminal. The wager response includes draw lottery ticket information that enables the lottery terminal to print the purchased draw lottery ticket.

As mentioned above, one issue with the above-described instant lottery tickets is that there are substantial variations in the structures, configurations, and arrangements of the individual components of the inventory control numbers and barcodes for such instant lottery tickets. These variations most often occur on a jurisdictional basis and can occur on a manufacturer basis. Such instant lottery tickets also can have substantial variations in their purchase prices and payout amounts for winning lottery tickets. This wide variety of the purchase prices, payout amounts for winning lottery tickets, and of the structures, configurations, and arrangements of the individual components of the inventory control numbers and barcodes for instant lottery tickets limits the types of systems that can be used to activate, sell, validate, and redeem such instant lottery tickets. For example, the above-described example instant lottery ticket packs must be activated by dedicated lottery terminals prior to purchase of any of the instant lottery tickets in such instant lottery ticket packs. This limits the locations that such instant lottery tickets can be purchased to the locations that have dedicated lottery terminals.

Various embodiments of the present disclosure address these various issues to enable lottery tickets such as instant lottery tickets and draw lottery tickets having variable purchase prices and/or variable payout amounts for winning lottery tickets to be activated, purchased, validated, and/or redeemed via POS systems at a substantially greater quantity of locations.

Various embodiments of the present disclosure provide a POS lottery ticket data interceptor for POS systems, and systems and methods employing such POS lottery ticket data interceptors with POS systems that enable activation, validation, purchase and/or redemption of lottery tickets having variable purchase prices and/or variable payout amounts for winning lottery tickets by such POS systems (such as but not limited to conventional retailer or wholesaler POS systems). This substantially expands the quantity of locations that such different lottery tickets can be purchased and redeemed.

### First Example Interceptor

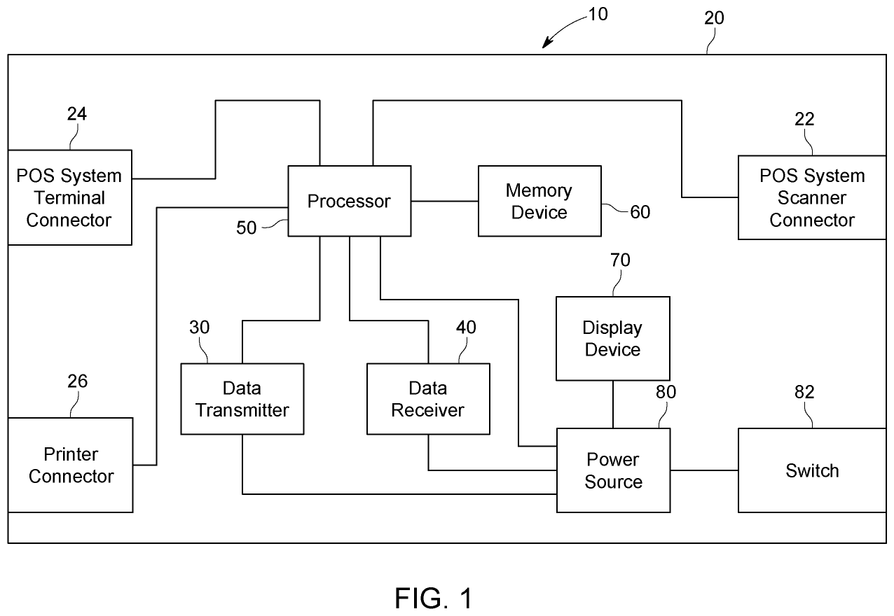

FIG. 1 illustrates an example POS lottery ticket data interceptor 10 of one example embodiment of the present disclosure that is configured to be communicatively and operably connected to and between a POS system scanner and a POS system terminal of a POS system. The POS lottery ticket data interceptor 10 includes: (1) a housing 20; (2) a POS system scanner connector 22; (3) a POS system terminal connector 24; (4) a data transmitter 30; (5) a data receiver 40; (6) a processor 50; (7) a memory device 60; (8) a display device 70 (which can include a touch-screen input device); and (9) a power source 80 (and one or more associated power or mode switches 82). In various embodiments, the POS lottery ticket data interceptor 10 additionally includes: (10) a printer connector 26.

In alternative embodiments, the POS lottery ticket data interceptor can be configured without a display device. In such embodiments, the POS lottery ticket data interceptor can have one or more other status indicators (such as one or more LED lights).

The POS lottery ticket data interceptor 10 may sometimes be referred to herein as the POS data interceptor or the POS interceptor for brevity. This example POS data interceptor 10 is thus configured to be communicatively and operably connected by hardwires to both of and between a POS system scanner and a POS system terminal of a POS system. The POS interceptor 10 is configured to receive and transmit data in the form of electrical signals or communications in a conventional manner or any new matter subsequently developed. For brevity, the data signals may be referred to herein is data or different types of data as described below.

The POS data interceptor 10 is generally configured to: (i) monitor and intercept scan data received from a POS system scanner; (ii) analyze the scan data received from the POS system scanner; (iii) if the scan data is not lottery ticket related data, relay or otherwise transmit that scan data to the POS system terminal (in a conventional manner); (iii) if the scan data is lottery ticket related data, transmit data based on that lottery ticket related data in real time to a lottery central system; (iv) receive lottery ticket data from the lottery central system; and (v) transmit data to the POS system terminal and thus the POS system to enable and facilitate the purchase of a lottery ticket.

More specifically, the housing 20 provides a suitable compartment for supporting various components of the POS data interceptor 10 in a compact and durable manner. The housing 20 can be configured in any suitable manner.

The POS system scanner connector 22 is supported by the housing 20, connected to the processor 50, and is configured to be connected to a POS system scanner (such as via a plug connected to a wire extending from the POS system scanner). The POS system scanner connector 22 is configured to facilitate the receipt of scan data from the POS system scanner after the POS system scanner scans a code (such as a barcode) on a product or a lottery ticket information provider and provide that scan data to the processor 50. For purposes of this disclosure, as further explained below, a lottery ticket information provider can be a lottery ticket itself or a provider of information relating to lottery ticket.

The POS system terminal connector 24 is supported by the housing 20, connected to the processor 50, and is configured to be connected a POS system terminal (such as via a wire plugged into the POS system terminal and plugged into the POS system terminal connector 24). The POS system terminal connector 24 is configured to facilitate the transmission of scan data from the processor 50 (or the POS system scanner) to the POS system terminal as well as the transmission of lottery ticket data to the POS system terminal. The lottery ticket data can be based on data received by the POS data interceptor 10 from a lottery central system or other suitable lottery ticket data. In various embodiments, the POS system terminal connector 24 of the POS data interceptor 10 can include a wire connected to the housing 20 and a plug at the end of the wire that is configured to be connected to the POS system terminal (in place of the plug from the POS system scanner typically connected to the POS system terminal).

The data transmitter 30 and the data receiver 40 are supported by the housing, connected to the processor 50, and can be any suitable combined device or separate devices that is/are configured to communicate data on a real time basis with the lottery central system (such as via a suitable data network), the POS system terminal, or other suitable devices such as explained below.

The processor 50 and the memory device 60 are supported by the housing and can be any suitable combined device or separate devices that is/are configured to process data on a real time basis and to control certain of the components of the POS data interceptor 10 such as discussed herein. The processor can include one or more suitable processing devices such as, but not limited to, a general-purpose processor, a special-purpose processor, a digital-signal processor, one or more microprocessors, one or more microprocessors in association with a digital-signal processor core, one or more application-specific integrated circuits, one or more field-programmable gate array circuits, one or more integrated circuits, and/or a state machine. The memory device can include one or more suitable memory devices such as, but not limited to, read-only memory, random-access memory, one or more digital registers, cache memory, one or more semiconductor memory devices, magnetic media such as integrated hard disks and/or removable memory, magneto-optical media, and/or optical media. The memory device stores instructions executable by the processor to control operation of the POS data interceptor 10 such as described herein.

In various embodiments, the memory device stores computer program instructions may be provided to the processor, such that the instructions, which execute via the processor of the computer or other programmable instruction execution apparatus, create a mechanism for implementing various functions/acts specified in the present disclosure. These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified herein. The computer program instructions may also be loaded onto a computer, other programmable instruction execution apparatus, or other devices to cause a series of operational steps to be performed on the computer, other programmable apparatuses, or other devices to produce a computer implemented process such that the instructions which execute on the computer or other programmable apparatus provide processes for implementing the functions/acts specified herein.

In the embodiments that include the display device 70, the display device 70 is supported by the housing 20, connected to the processor 50, and configured to display various information regarding the POS data interceptor 10 under the control of the processor 50. The displayed information can include the different states, modes, or operating conditions of the POS data interceptor 10, or can be related to the data processed by the POS data interceptor 10. In the alternative embodiments that include the status indicator(s), each such status indicator is supported by the housing 20, connected to the processor 50, and configured to indicate various information regarding the POS data interceptor 10 under the control of the processor 50. The indicator(s) can indicate different states, modes, or operating conditions of the POS data interceptor 10, or can be related to the data processed by the POS data interceptor 10.

The power source 80 and the power and/or mode switch(es) 82 are supported by the housing 20 and can be any suitable power source and switch(es) that function to provide electrical power to the various components of the POS data interceptor 10, the turn the POS data interceptor 10 on and off, and/or change modes of the POS data interceptor 10.

### Second Example Interceptor

In alternative embodiments, the POS lottery ticket data interceptor can be configured with an additional scanner, such as a dedicated lottery ticket scanner or interceptor scanner (not shown). In these embodiments, the POS lottery ticket data interceptor includes an interceptor scanner connector, alternatively to the POS system scanner connector 22. In these embodiments, the POS lottery ticket data interceptor can be connected to the POS system terminal, and the operator can use the additional interceptor scanner for scanning lottery tickets or lottery ticket sheets and to obtain lottery ticket related data.

In these embodiments, the POS lottery ticket data interceptor is configured to be communicatively and operably connected by hardwires to both of and between that additional interceptor scanner and a POS system terminal of a POS system. In various embodiments, the POS data interceptor is generally configured to: (i) monitor scan data received from the additional interceptor scanner; (ii) analyze the scan data received from the additional interceptor scanner; (iii) if the scan data is not lottery ticket related data, transmit that scan data to the POS system terminal; (iii) if the scan data is lottery ticket related data, transmit data based on that lottery ticket related data in real time to a lottery central system; (iv) receive lottery ticket data from the lottery central system; and (v) transmit data to the POS system terminal and thus the POS system to enable and facilitate the purchase of a lottery ticket. In some embodiments, if the scan data is not lottery ticket related data, the POS data interceptor relays or otherwise transmits that scan data to the POS system terminal (in a conventional manner).

### First Example Implementation of Interceptor

FIG. 2 illustrates a system 100 (and related method) employing a POS data interceptor 10 with a lottery central system 150, a POS system scanner 115, a POS system terminal 110 of a POS system (not shown), and POS system receipt printer 120 in accordance with a first example embodiment of the present disclosure. In this example embodiment, the lottery ticket information provider is a scratch off instant lottery ticket T1 and the system 100 facilitates the purchase of this scratch off instant lottery ticket T1.

In operation of this example embodiment, an operator of the POS system scanner 115 scans the I2of5 barcode (that contains Game/Pack/Ticket ID) of the instant lottery ticket T1 that a customer has indicated that the customer wants to purchase. Such instant lottery tickets can be maintained and displayed close to the POS system terminal 110 or in another suitable location. It should be appreciated that such instant lottery tickets can be activated on a pack or on a ticket level as discussed herein. The POS data interceptor 10 monitors the scan data from scans by the POS system scanner 115 and reacts if lottery ticket related data (including the I2of5 content) is received from the POS system scanner 115. Specifically, responsive to receiving lottery ticket related data (including the I2of5 content), the POS data interceptor 10 decodes the lottery ticket related data (including the I2of5 content) and creates in real time ticket activation request data based on the I2of5 content. The POS data interceptor 10 transmits via the data transmitter 30 (and via a suitable data network 140) in real time the ticket activation request data to the lottery central system 150. The lottery central system 150 processes the ticket activation request data and creates in real time ticket activation response data. The lottery central system 150 also updates the lottery ticket status to activated in its systems (assuming the lottery ticket activation request data relates to a valid lottery ticket). The POS lottery ticket data interceptor 10 waits for the ticket activation response data from the lottery centra system 150 before it sends an UPC code to the POS system. The ticket activation response data can either include a ticket activation confirmation or a ticket activation denial. The lottery central system 150 transmits in real time (and via the suitable data network 140) the ticket activation response data to the data receiver 40 of the POS lottery ticket data interceptor 10. Responsive to receiving the ticket activation response data, POS lottery ticket data interceptor 10 determines in real time if the ticket activation response data includes a ticket activation confirmation or a ticket activation denial. If the ticket activation response data includes a ticket activation denial, the POS lottery ticket data interceptor 10 does not send a UPC code to the POS system terminal 110. Rather, the POS lottery ticket data interceptor 10 sends suitable error code data to the POS system terminal 110 for enabling the POS system terminal 110 to display and such that an operator can indicate the error or issue to the customer and address such error or issue in a suitable manner. If the ticket activation response data includes a ticket activation confirmation, the POS lottery ticket data interceptor 10 looks up in its memory device 60 the UPC code associated with this instant lottery ticket T1 based on the Game Identification (“D”) it has stored and creates and transmits UPC data for this instant lottery ticket T1 to the POS system terminal 110. Responsive to receipt of this UPC data for this instant lottery ticket T1, the POS system terminal 110 adds a lottery sale to the POS shopping cart that it created for the customer in a conventional manner. The operator of the POS system terminal 110 obtains payment for all items in this POS shopping cart for the customer and provides the customer with the instant lottery ticket T1 and a receipt printed by the POS system receipt printer 120.

In this example embodiment, if the scan data received by the POS data interceptor 10 from the POS system scanner 115 does not include lottery ticket related data, the POS data interceptor 10 relays or otherwise transmits that scan data to the POS system terminal 110, and the POS system terminal 110 processes that scan data in a conventional manner.

In this example embodiment, the memory device 60 stores data regarding the UPC codes for the instant lottery ticket T1 (and other lottery tickets) available at the location of the POS system. In various embodiments, obtaining this data can be part of initiation and/or update processes between the POS data interceptor 10 and the lottery central system. In various embodiments, the lottery system and the retailer will agree on the respective different UPC codes that the POS data interceptor 10 will provide to the lottery system terminal 110 for all of the different types of lottery tickets that will be sold by such retailer. In various embodiments, the retailer will be responsible for ensuring all such UPC codes (and related definitions) are loaded into or otherwise known by POS system and lottery system and/or the retailer will have a remote tool to update POS Connect with the same UPC codes (and related definitions).

In this example embodiment, the instant lottery ticket T1 from the pack of instant lottery tickets that contains the instant lottery ticket T1, is activated at the time of purchase and the pack does not need to be activated before such purchase of the instant lottery ticket T1.

In various other embodiments, lottery ticket pack activation and other pack management activities by retailers will be preformed separately from the system 10 and from the POS system. In various such embodiments, such actions are provided through a separate system that enables retailers access to manage and administrate the lottery category for reporting, invoicing, ordering, communications etc. This can include the ability to order more instant lottery tickets, and can support lottery ticket pack management including pack activation.

In various other example embodiments, before allowing a customer to purchase any instant lottery tickets from the pack of instant lottery tickets that contains the instant lottery ticket T1, the system can enable an operator of the POS system scanner 115 to activate the pack of instant lottery tickets containing instant lottery ticket T1. This can be done in any suitable manner such as in the following example manner. In this example, the POS data interceptor 10 has a pack activation mode and the operator of the POS system scanner 115 can place the POS data interceptor 10 in this pack activation mode. In this pack activation mode, the operator can scan the I2of5 barcode (that contains Game/Pack/Ticket ID) of one of the instant lottery tickets in a pack (such as the pack that contains the instant lottery ticket T1). In this pack activation mode, the POS data interceptor 10 monitors the scan data from scans by the POS system scanner 115 and reacts and responsive to receiving lottery ticket related data (including I2of5 content). Specifically, the POS data interceptor 10 decodes the I2of5 content and creates in real time ticket pack activation request data based on the I2of5 content. The POS data interceptor 10 transmits via the data transmitter 30 (and via the suitable data network 140) in real time the ticket pack activation request data to the lottery central system 150. The lottery central system 150 processes the ticket pack activation request data and creates in real time ticket pack activation response data. The lottery central system verifies that this ticket pack activation request data came from the correct receiver of this pack of instant lottery tickets and creates ticket pack activation response data. The ticket pack activation response data can either include a ticket pack activation confirmation or a ticket pack activation denial. The lottery central system 150 transmits in real time (and via the suitable data network 140) the ticket pack activation response data to the data receiver 40 of the POS lottery ticket data interceptor 10. Responsive to receiving the ticket pack activation response data, the POS lottery ticket data interceptor 10 determines in real time if the ticket pack activation response data includes a ticket pack activation confirmation or a ticket pack activation denial. If the ticket pack activation response data includes a ticket activation denial, the POS lottery ticket data interceptor 10 sends suitable error code data to the POS system terminal 110 for enabling the POS system terminal 110 to display and such that an operator can indicate the error or issue to address such error or issue in a suitable manner. If the ticket pack activation response data includes a ticket pack activation confirmation, the POS lottery ticket data interceptor 10 displays via its display device 70 a confirmation to the operator that the ticket pack has been activated. Thereafter, the instant lottery tickets in that pack are ready for purchase.

In various other embodiments, the POS data interceptor 10 is configured with an additional interceptor scanner (not shown but described above). In these other embodiments, the operator employs the additional interceptor scanner alternatively to the POS system scanner 115 for the purchase of the scratch off instant lottery ticket T1 and/or the activation of the instant lottery ticket as described above.

### Second Example Implementation of Interceptor

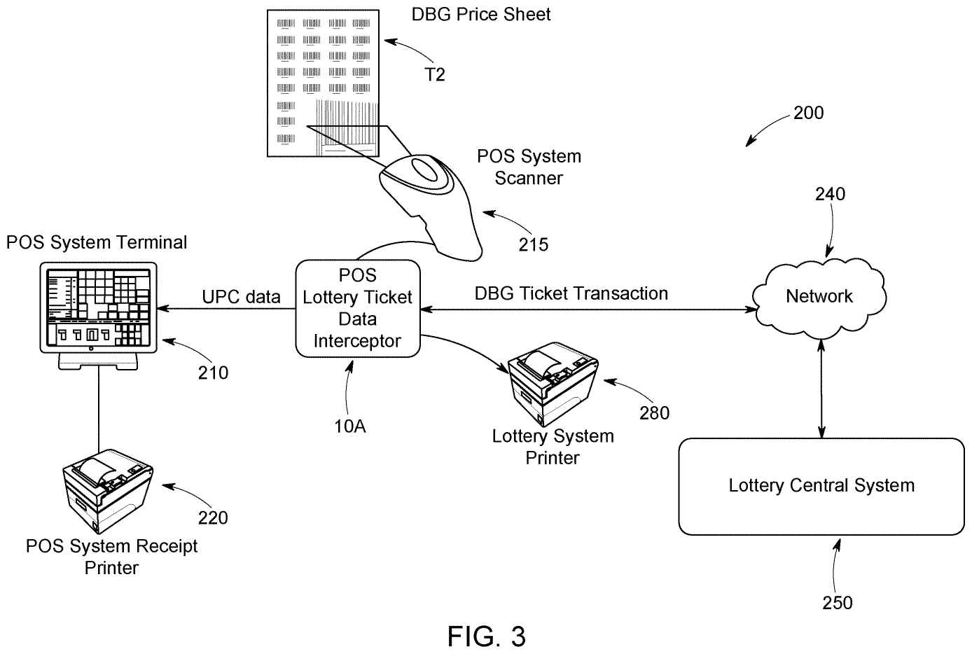

FIG. 3 illustrates a system 200 (and related method) employing a POS data interceptor 10A with a lottery central system 250, a POS system scanner 215, a POS system terminal 210, and POS system receipt printer 220 in accordance with a second example embodiment of the present disclosure. In this example embodiment, the lottery ticket information provider is a pre-printed draw lottery ticket DBG price sheet T2 (for a draw-based game) that includes a plurality of different UPC codes for a plurality of different draw lottery tickets for a plurality of different draw lottery games (and purchase prices for such lottery tickets). In various embodiments, each different lottery game and each different price point for such lottery game has a different UPC code associated therewith. The system 200 facilitates the purchase of these draw lottery tickets.

In operation of this example embodiment, an operator of the POS system scanner 215 scans the respective UPC barcode of the draw lottery ticket DBG price sheet T2 corresponding to a draw lottery ticket that a customer has indicated that the customer wants to purchase. Such draw lottery ticket DBG price sheet T2 can be maintained and displayed close to the POS system terminal 110 or in another suitable location. In other embodiments, other methods for the DBG UPC code scanning can be employed. For example, a playcard that has the lottery game and purchase price with a barcode printed for the operator to scan the UPC can be employed. The POS data interceptor 10A monitors the scan data from scans by the POS system scanner 215 and reacts if lottery ticket related data (including this UPC barcode) is received from the POS system scanner 215. Specifically, responsive to receiving lottery ticket related data (including this UPC barcode), the POS data interceptor 10A creates in real time draw game wager request data based on this UPC barcode. The POS data interceptor 10 transmits via the data transmitter 30 (and via a suitable data network 240) in real time the draw game wager request data to the lottery central system 250. The lottery central system 250 processes the draw game wager request data and creates in real time draw game wager response data. In various embodiments, the lottery system processes the wager as any other wager request from a 3rd party system. In various embodiments, a front-end/gateway system can be employed to enable 3rd party systems to transact with the lottery central system. The draw game wager response data can either include a wager confirmation or a wager denial. The lottery central system 250 transmits (via the suitable data network 240) in real time the draw game wager response data to the data receiver 40 of the POS lottery ticket data interceptor 10A. Responsive to receiving the draw game wager response data, the POS lottery ticket data interceptor 10A determines in real time if the draw game wager response data includes a wager confirmation or a wager denial. If the draw game wager response data includes a wager denial, the POS lottery ticket data interceptor 10A sends suitable error code data to the POS system terminal 210 for enabling the POS system terminal 210 to display and such that an operator can indicate the error or issue to address such error or issue in a suitable manner. If the draw game wager response data includes a wager confirmation, the POS lottery ticket data interceptor 10A causes the lottery system printer 280 to print the draw lottery ticket and transmits the UPC code for this draw lottery ticket to the POS system terminal 210. The POS system terminal 210 adds this lottery sale to the POS shopping cart that it created for the customer. The operator of the POS system terminal 210 obtains payment for all items in the POS shopping cart for the customer and provides the customer with the printed lottery ticket and a receipt printed by the POS system receipt printer 220.

In this example embodiment, if the scan data received by the POS data interceptor 10A from the POS system scanner 215 does not include lottery ticket related data, the POS data interceptor 10A relays or otherwise transmits that scan data to the POS system terminal 210, and the POS system terminal 210 processes that scan data in a conventional manner.

In this example embodiment, the POS data interceptor 10A or the lottery central system can determine the symbols (such as the numbers) for the draw lottery ticket. For example, the numbers for a play of a quick pick DBG lottery ticket can be determined by the lottery central system and can be part of the wager confirmation response. The POS data interceptor 10A can cause the lottery ticket with these numbers to be printed on the connected lottery system printer 280.

In various other embodiments, the POS data interceptor 10A is configured with an additional interceptor scanner (not shown but described above). In these other embodiments, the operator employs the additional interceptor scanner alternatively to the POS system scanner 215 for the purchase of the draw lottery tickets.

### Third Example Implementation of Interceptor

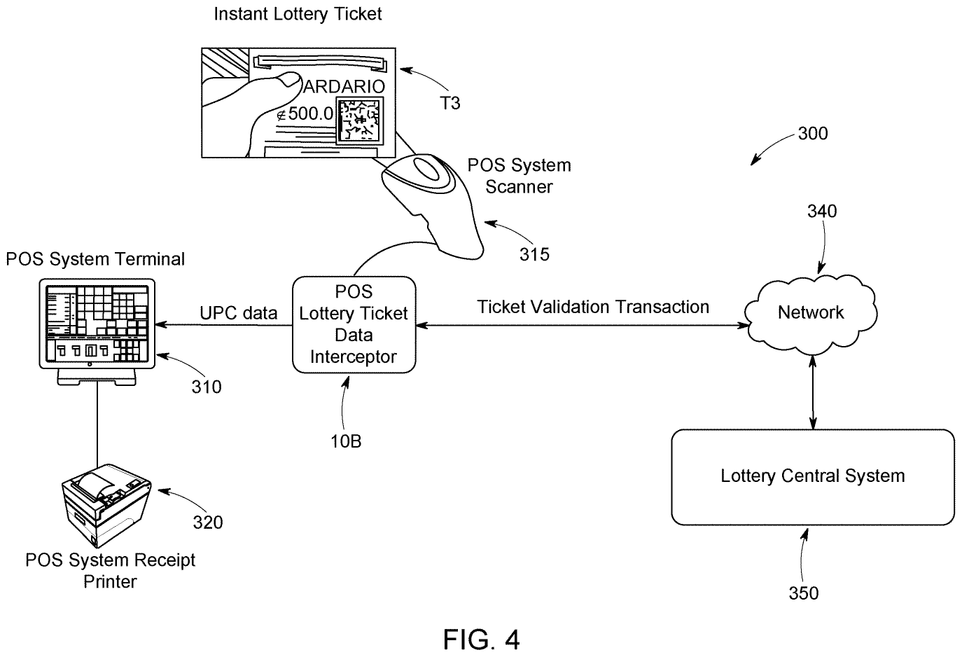

FIG. 4 illustrates a system 300 (and related method) employing a POS data interceptor 10B with a lottery central system 350, a POS system scanner 315, a POS system terminal 310, and POS system receipt printer 320 in accordance with a third example embodiment of the present disclosure. In this example embodiment, the lottery ticket information provider is a scratch off instant lottery ticket T3 and the system 300 is configured to validate the instant lottery ticket T3 for redemption (and thus payout of any winning amounts to the holder (customer) of the instant lottery ticket T3).

In operation of this example embodiment, an operator of the POS system scanner 315 scans the ticket redemption (PDF417) barcode of the instant lottery ticket T3 that a customer has indicated that the customer wants to redeem. The POS data interceptor 10B monitors the scan data from scans by the POS system scanner 315 and reacts if lottery ticket redemption related data is received from the POS system scanner 315. Specifically, responsive to receiving lottery ticket redemption related data, the POS data interceptor 10B decodes the lottery ticket redemption data and creates in real time ticket redemption request data based thereon. The POS data interceptor 10B transmits via the data transmitter 30 (and via a suitable data network 340) in real time the ticket redemption request data to the lottery central system 350. The lottery central system 350 processes the ticket redemption request data and creates in real time ticket redemption response data. The lottery system verifies the status and prize of lottery ticket and provides the relevant response as well as updates the status of lottery ticket in it database(s). The ticket redemption response data can include data relating to the instant lottery ticket T3 indicating regarding such ticket one of the following categories: (1) no win, (2) low-tier win amount, (3) mid-tier win amount, and (4) high-tier win amount. The ticket redemption response data can include for each of the low-tier win amount and the mid-tier win amount, a respective amount to be paid to the customer. The ticket redemption response data can include for the high tier win amount an amount won by the customer, that the customer must seek payment in an alternative manner from the lottery system.

The lottery central system 350 transmits (via the suitable data network 340) in real time the ticket redemption response data to the data receiver 40 of the POS lottery ticket data interceptor 10B. Responsive to receiving the ticket redemption response, POS lottery ticket data interceptor 10B determines in real time one of four different UPC codes. Each different code corresponds to a different on of the following categories: (1) no win, (2) low-tier win amount, (3) mid-tier win amount, and (4) high-tier win amounts. As indicated above, this ticket redemption response can include data regarding the prize amounts to be paid to the customer. This can be performed in different manners in accordance with the present disclosure.

The POS lottery ticket data interceptor 10B looks up in its memory device 60 the UPC code corresponding to the respective category of the instant lottery ticket T3 and creates and transmits UPC data for this instant lottery ticket T3 to the POS system terminal 310. In various embodiments, the UPC code type can be configured such that adjustments can be made to the value of the goods per transaction. This is somewhat similar to how some goods like fruits and vegetables with a total weight price scanned at POS system has a variable price when scanned.

Responsive to the UPC code corresponding to the no win category, the POS system terminal 310 can provide a receipt printed by the POS system receipt printer 320 but does not provide the customer any pay-out for this instant lottery ticket T3.

Responsive to the UPC code corresponding to the low-tier win amount, the POS system terminal 310 adds a lottery ticket credit to the POS shopping cart if the UPC code corresponds to the low-tier win amount. The operator of the POS system terminal 310 can provide a payment to the customer (depending on all items in the POS shopping cart for the customer) and can provide a receipt printed by the POS system receipt printer 320. The receipt can be part of a separate shopping checkout receipt (such as a receipt printed at checkout on the POS system).

Responsive to the UPC code corresponding to the mid-tier win amount, the POS system terminal 310 adds a lottery ticket credit to the POS shopping cart if the UPC code corresponds to the mid-tier win amount. The operator of the POS system terminal 310 can provide a payment to the customer (depending on all items in the POS shopping cart for the customer) and can provide a receipt printed by the POS system receipt printer 320. In various embodiments, a mid-tier win amount can require approval by more than one operator. The receipt can be part of a separate shopping checkout receipt (such as a receipt printed at checkout on the POS system).

Responsive to the UPC code corresponding to the high tier win amount, the POS system terminal 310 can provide a receipt printed by the POS system receipt printer 320. The printed receipt can include instructions for the customer for obtaining the high-tier pay-out. In other embodiments, such instructions can be separately provided to the customer.

In this example embodiment, if the scan data received by the POS data interceptor 10 from the POS system scanner 315 does not include lottery ticket related data, the POS data interceptor 10 relays or otherwise transmits that scan data to the POS system terminal 310, and the POS system terminal 310 processes that scan data in a conventional manner.

In this example embodiment, the memory device 60 stores data regarding the UPC codes for the instant lottery ticket T3.

In various other embodiments, the POS data interceptor 10B is configured with an additional interceptor scanner (not shown but described above). In these other embodiments, the operator employs the additional interceptor scanner alternatively to the POS system scanner 315 for the validation of the instant lottery ticket T3 for redemption.

### Fourth Example Implementation of Interceptor

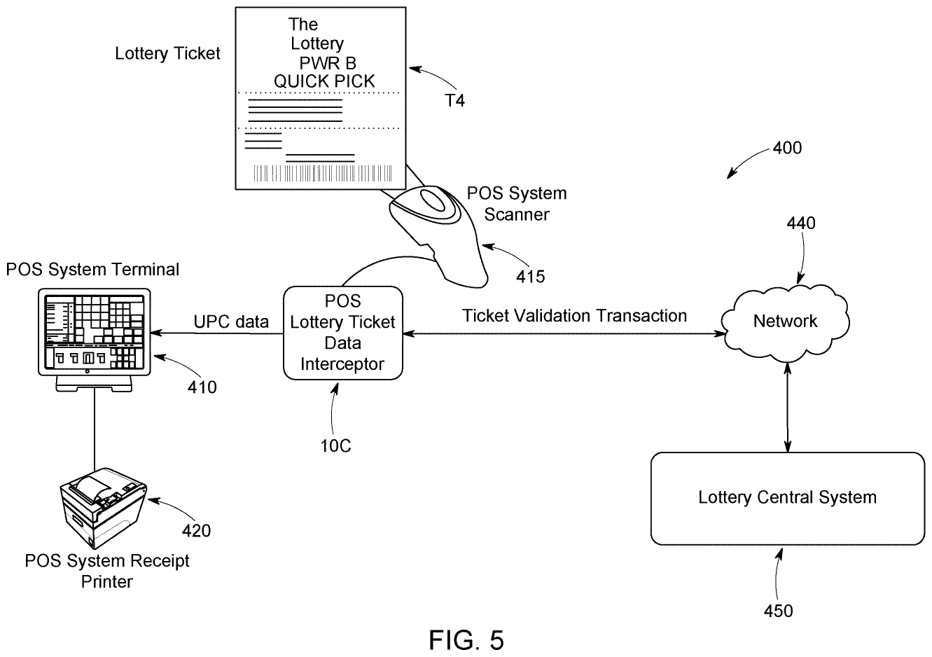

FIG. 5 illustrates a system 400 (and related method) employing a POS data interceptor 10C with a lottery central system 450, a POS system scanner 415, a POS system terminal 410, and POS system receipt printer 420 in accordance with a fourth example embodiment of the present disclosure. In this example embodiment, the lottery ticket information provider is a draw lottery ticket T4 and the system 400 is configured to validate the draw lottery ticket T4 for redemption (and thus payout of any winning amounts to the holder (customer) of the draw lottery ticket T4).

In operation of this example embodiment, an operator of the POS system scanner 415 scans the ticket ID barcode of the draw lottery ticket T4 that a customer has indicated that the customer wants to redeem. The POS data interceptor 10C monitors the scan data from scans by the POS system scanner 415 and reacts if lottery ticket redemption related data is received from the POS system scanner 415. Specifically, responsive to receiving lottery ticket redemption related data, the POS data interceptor 10C decodes the lottery ticket redemption data and creates in real time ticket redemption request data based thereon. The POS data interceptor 10C transmits via the data transmitter 30 (and via a suitable data network 440) in real time the ticket redemption request data to the lottery central system 450. The lottery central system 450 processes the ticket redemption request data and creates in real time ticket redemption response data. The lottery system validates the DBG lottery ticket similar to other draw-based game validations. The ticket redemption response data determine the actions of POS data interceptor 10C. The ticket redemption response data can include a ticket redemption response that includes data regarding the ticket indicating one of the following categories: (1) no win; (2) low-tier win amount; (3) mid-tier win amount; and (4) high-tier win amount. As indicated above, this ticket redemption response can include data regarding the prize amounts to be paid to the customer. This can be performed in different manners in accordance with the present disclosure.

The lottery central system 450 transmits (via the suitable data network 440) in real time the ticket redemption response data to the data receiver 40 of the POS lottery ticket data interceptor 10C. Responsive to receiving the ticket redemption response data, POS lottery ticket data interceptor 10C determines in real time one of four different UPC codes. Each different code corresponds to a different one of the following categories: (1) no win; (2) low-tier win amount; (3) mid-tier win amount; and (4) high-tier win amount.

The POS lottery ticket data interceptor 10C looks up in the memory device 60 the UPC code and creates and transmits UPC data for this draw lottery ticket T4 to the POS system terminal 410.

Responsive to the UPC code corresponding to the no win category, the POS system terminal 410 can provide a receipt printed by the POS system receipt printer 420 but does not provide the customer any pay-out for this draw lottery ticket T4.

Responsive to the UPC code corresponding to the low-tier win amount, the POS system terminal 410 adds a lottery ticket credit to the POS shopping cart if the UPC code corresponds to the low-tier win amount. The operator of the POS system terminal 410 can provide a payment to the customer (depending on all items in the POS shopping cart for the customer) and can provide a receipt printed by the POS system receipt printer 420.

Responsive to the UPC code corresponding to the mid-tier win amount, the POS system terminal 410 adds a lottery ticket credit to the POS shopping cart if the UPC code corresponds to the mid-tier win amount. The operator of the POS system terminal 410 can provide a payment to the customer (depending on all items in the POS shopping cart for the customer) and can provide a receipt printed by the POS system receipt printer 420. In various embodiments, a mid-tier win amount can require approval by more than one operator. The receipt can be part of a separate shopping checkout receipt (such as a receipt printed at checkout on the POS system).

Responsive to the UPC code corresponding to the high tier win amount, the POS system terminal 410 can provide a receipt printed by the POS system receipt printer 420. The printed receipt can include instructions for the customer for obtaining the high-tier pay-out. In other embodiments, such instructions can be separately provided to the customer.

In this example, if the scan data received by the POS data interceptor 10C from the POS system scanner 415 does not include lottery ticket related data, the POS data interceptor 10C relays that scan data to the POS system terminal 410, and the POS system terminal 410 processes that scan data in a conventional manner.

In this example, the memory device 60 stores data regarding the UPC codes for the draw lottery ticket T4.

In various other embodiments, the POS data interceptor 10C is configured with an additional interceptor scanner (not shown but described above). In these other embodiments, the operator employs the additional interceptor scanner alternatively to the POS system scanner 415 for the validation of the draw lottery ticket T4 for redemption.

### Fifth Example Implementation of Interceptor

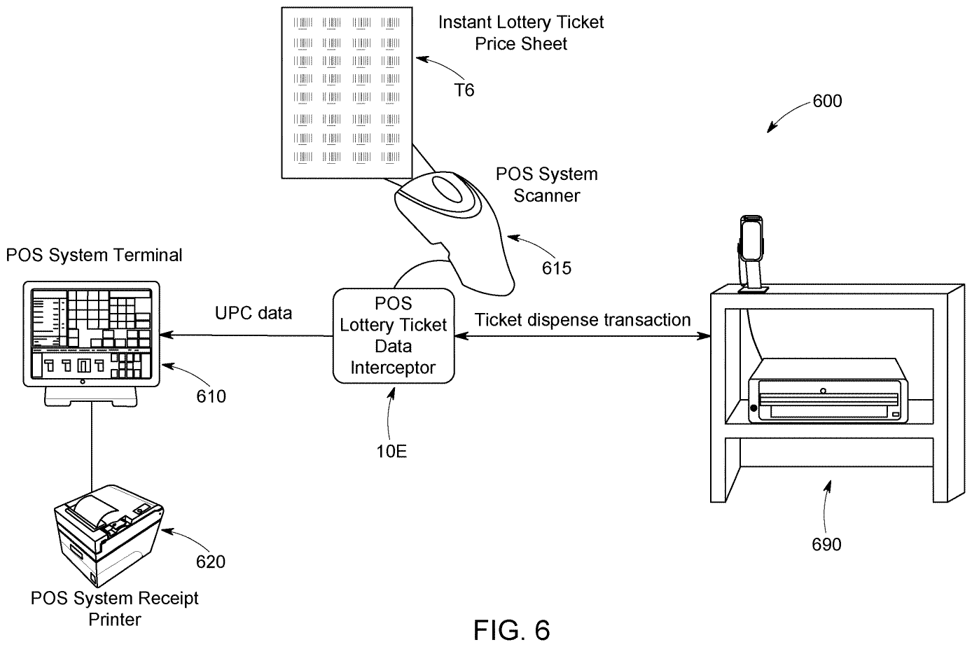

FIG. 6 illustrates a system employing a POS lottery ticket data interceptor for a POS system in accordance with a fifth example embodiment of the present disclosure.

More specifically, FIG. 6 illustrates a system 600 (and related method) employing a POS data interceptor 10E, a POS system scanner 615, a POS system terminal 610, a POS system receipt printer 620, and a POS system dispenser 690 in accordance with a fifth example embodiment of the present disclosure. In this example embodiment, the lottery ticket information provider is a pre-printed instant lottery ticket price sheet T6 that includes a plurality of different UPC codes for a plurality of different instant lottery tickets and their respective prices. The system 600 facilitates the purchase of these instant lottery tickets.

In operation of this example embodiment, an operator of the POS system scanner 615 scans the respective UPC barcode of the instant lottery ticket price sheet T6 corresponding to an instant lottery ticket that a customer has indicated that the customer wants to purchase. Such instant lottery ticket price sheet T6 can be maintained and displayed close to the POS system terminal 610 or in another suitable location. The POS data interceptor 10E monitors the scan data from scans by the POS system scanner 615 and reacts if lottery ticket related data (including the UPC barcode) is received from the POS system scanner 615. Specifically, responsive to receiving lottery ticket related data (including the UPC barcode), the POS data interceptor 10E creates in real time dispense request data based on the UPC barcode. The POS data interceptor 10E transmits via the data transmitter 30 in real time the dispense request data to the POS dispenser 690. The POS dispenser 690 processes the dispense request data and creates and dispenses an instant lottery ticket. The POS dispenser 690 also creates in real time dispense response data. The dispense response data can either include a dispense confirmation or a dispense denial. The POS dispenser 690 transmits in real time the dispense response data to the data receiver 40 of the POS lottery ticket data interceptor 10E. Responsive to receiving the dispense response data, POS lottery ticket data interceptor 10E determines in real time if the dispense response data includes a dispense confirmation or a dispense denial. If the dispense response data includes a dispense denial, the POS lottery ticket data interceptor 10E sends suitable error code data to the POS system terminal 610 for enabling the POS system terminal 610 to display and such that an operator can indicate the error or issue to address such error or issue in a suitable manner. If the dispense response data includes a dispense confirmation, the POS lottery ticket data interceptor 10E transmits the UPC code for this instant lottery ticket to the POS system terminal 610. The POS system terminal 610 adds a lottery sale to the POS shopping cart that it created for the customer. The operator of the POS system terminal 610 obtains payment for all items in the POS shopping cart for the customer. The operator of the POS system terminal provides the customer with the printed instant lottery ticket created by the POS dispenser 690 and a receipt printed by the POS system receipt printer 620.

In this example, if the scan data received by the POS data interceptor 10E from the POS system scanner 615 does not include lottery ticket related data, the POS data interceptor 10E relays that scan data to the POS system terminal 610, and the POS system terminal 610 processes that scan data in a conventional manner.

In various embodiment, the POS dispenser 690 only communicates with a lottery central system (not shown in FIG. 6) though the POS data interceptor 10E to receive data from and provide data regarding the instant lottery ticket to the lottery central system.

In various alternative embodiments, the POS dispenser 690 can also communicate with a lottery central system (not shown in FIG. 6) to provide data regarding the instant lottery ticket to the lottery central system.

In various other embodiments, the POS data interceptor 10E is configured with an additional interceptor scanner (not shown but described above). In these other embodiments, the operator employs the additional interceptor scanner alternatively to the POS system scanner 615 for the purchase of the instant lottery tickets.

### Sixth Example Implementation of Interceptor

In certain known POS systems, certain products that are available for purchase are associated with product codes that are licensed from a business standards entity, such as GS1 which offers a GS1 Company Prefix license that enables creation of Global Trade Item Numbers (GTINs) and associated barcodes for product identification. Certain such licensed product codes can be used to identify a particular product, which can then be associated with a purchase price set by each store at which the product is sold. In some scenarios, licensing costs associated with such product codes and a potential for procedural delays when changing products associated with such product codes can limit the quantity and/or variability of product codes available for use for different products. This limited quantity and/or variability can reduce an ability of a lottery system operator to offer new lottery game types and/or modify existing lottery game types for lottery tickets. This limited quantity and/or variability can also reduce an ability of a POS system operator to accurately track the purchase and/or redemption of such lottery tickets. With purchase prices set by the stores, lottery system operators have a limited ability to: (1) efficiently set and/or modify purchase prices for lottery tickets; and/or (2) start and stop a lottery ticket promotion for lottery tickets.

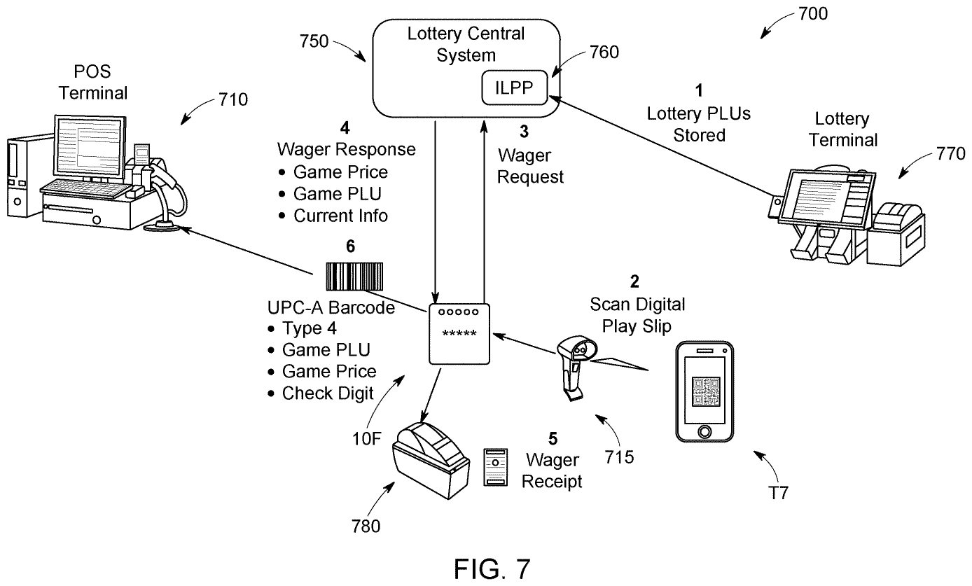

FIG. 7 illustrates a system 700 (and related method) employing a POS data interceptor 10F with a lottery central system 750, a POS system scanner 715, a POS system terminal 710, a lottery terminal 770, and a lottery system printer 780 in accordance with a sixth example embodiment of the present disclosure. In various embodiments, the system 700 employs a lottery product identifier (such as a price look-up or PLU number) and a lottery ticket value identifier to enable generation in real time of a product code (such as a UPC) that is specific to a purchase of a lottery ticket (e.g., a draw lottery ticket and/or instant lottery ticket) having a particular purchase price (e.g., based on optional features associated with that lottery ticket and/or applicable lottery ticket promotions) and specific to a POS system or retail store at which the purchase was made. In some embodiments, the system 700 employs the lottery product identifier (e.g., the PLU) and the lottery ticket value identifier to avoid the use of a limited quantity of licensed, static product codes (e.g., UPCs). In some embodiments, the system 700 employs the lottery product identifier and the lottery ticket value identifier to enable employment of a plurality of real time generated product codes in addition to a limited quantity of licensed, static product codes.

In this example embodiment, the lottery ticket information provider is a draw lottery ticket play slip T7 that includes a QR code and the system 700 facilitates purchases of draw lottery tickets having variable purchase prices based on the draw lottery ticket play slip T7.

The lottery central system 750 includes: (1) a housing; (2) a lottery terminal connector 760; (3) a data transmitter; (4) a data receiver; (5) a processor; and (6) a memory device. In this example embodiment, the lottery terminal connector 760 includes an in-lane proxy product (ILPP) that enables communication with the lottery terminal 770 via a suitable lottery application programming interface (API), such as a NASPL API. In other embodiments, the lottery terminal connector 760 includes another suitable communication interface.

The lottery terminal 770 includes: (1) a housing; (2) a lottery central system connector; (3) a display device (which can include a touch-screen input device); (4) a data transmitter; (5) a data receiver; (6) a processor; and (7) a memory device. In various embodiments, the lottery terminal 770 additionally includes a printer connector. In this example embodiment, the lottery central system connector enables communication with the lottery central system 750 via the NASPL API. In other embodiments, the lottery terminal 770 employs a different suitable communication interface. In this example embodiment, the lottery terminal 770 is located at a retail location of the POS system terminal 710. In other embodiments, the lottery terminal 770 is located at a retail management location (e.g., a management office of a retail chain associated with the POS system terminal 710).

In operation of this example embodiment, an operator of the lottery terminal 770, such as a retail chain manager associated with the POS system, inputs or modifies a lottery product identifiers (e.g., PLUs) associated with draw lottery tickets that are available for purchase from the POS system terminal 710. In some embodiments, the lottery terminal 770 displays a graphical user interface on a touch-screen display device that enables entry of lottery product identifiers (e.g., PLUs) by the retail chain manager. In some embodiments, the lottery central system 750 provides a web user interface or other suitable user input interface that enables the retail chain manager to input the lottery product identifiers. The lottery terminal 770 sends the lottery product identifiers and/or modifications to the lottery central system 750.

In various embodiments, the lottery product identifiers (e.g., PLUs) are employable to identify lottery ticket transactions, such as purchases and/or redemptions, for certain draw lottery tickets, such as draw lottery tickets associated with different draw lottery game types, selected optional features for such draw lottery tickets, certain draw lottery ticket promotions (e.g., discounts or bonuses), and/or other suitable variations in draw lottery tickets. In some embodiments, the lottery product identifiers indicate a transaction type for a draw lottery ticket (e.g., a purchase or redemption). In some embodiments, the optional features for the draw lottery ticket include an optional multiplier that, when selected, adds an additional cost (e.g., $1.00) to a purchase price of the draw lottery ticket and provides a multiplier to any non-jackpot winnings associated with the draw lottery ticket. It will be appreciated that other optional features for different draw lottery tickets can be employed by the lottery central system 750. In some embodiments, the draw lottery ticket promotions include a discounted purchase price, a free lottery ticket, a free optional feature, a free bonus draw date, a free set of player numbers, or other suitable promotions.

In various embodiments, the lottery product identifiers include in-store product identifiers that can vary from retail chain to retail chain or from retail store to retail store. In these embodiments, certain lottery product identifiers can be specific to a POS system, retail store, or retail chain. In various embodiments, the lottery product identifiers include price look-up (PLU) numbers, stock keeping unit (SKU) numbers, or other suitable product identifiers. It should be appreciated that different retail chains, retail stores, and/or POS systems can employ different lottery product identifiers for otherwise identical draw lottery tickets (i.e., draw lottery tickets having the same bet details but purchased from different retail stores can have different PLUs or SKUs).

In this example embodiment, each lottery product identifier includes a price look-up (PLU) number. Specifically, the lottery product identifier includes a 4-digit or 5-digit retailer assigned PLU code (for example, PLU codes 3170 to 3270) and each PLU indicates draw lottery tickets of a particular draw lottery game type, selected optional features for such draw lottery tickets, and/or other suitable variations in draw lottery tickets. As an example, a lottery product identifier of “3215” can indicate draw lottery tickets for a first draw lottery game type and a lottery product identifier of “3216” can indicate draw lottery tickets for a second draw lottery game type. As another example, a lottery product identifier of “3222” can indicate draw lottery tickets for a third draw lottery game type without an optional feature being selected and a lottery product identifier of “3223” can indicate draw lottery tickets for the third draw lottery game type with the optional feature being selected. As yet another example, a lottery product identifier of “3233” can indicate a purchase of draw lottery tickets for a fourth draw lottery game type.

The lottery central system 750 stores the lottery product identifiers (e.g., PLUs) for subsequent lottery ticket purchases from that POS system. In some embodiments, the lottery central system 750 stores a retailer identifier that identifies the POS data interceptor 10F associated with that POS system. The retailer identifier enables a lookup of lottery product identifiers that are specific to a POS system.

For a purchase of a draw lottery ticket in this example embodiment, an operator of the POS system scanner 715 scans the QR code of the draw lottery ticket play slip T7 that a customer has presented for the purchase.

In this example embodiment, the draw lottery ticket play slip T7 includes a digital play slip that is displayed by a display device of a player electronic device with a mobile application (not shown) downloaded thereon (e.g., an electronic smartphone, an electronic tablet, an electronic watch, or other suitable electronic computing device with suitable data communication, user input, and display functions). In some other embodiments, a customer can present a printed draw lottery ticket play slip that includes the QR code to be scanned by the POS system scanner 715.

The POS data interceptor 10F monitors the scan data from scans by the POS system scanner 715 and reacts if lottery ticket related data is received from the POS system scanner 715. Specifically, responsive to receiving lottery ticket related data (including scanned bet slip data associated with this QR code), the POS data interceptor 10F decodes the lottery ticket related data to obtain bet details for the purchase of the draw lottery ticket and creates in real time draw game wager request data based thereon. In certain embodiments, the draw game wager request data additionally includes the retailer identifier that identifies the POS system and/or the POS data interceptor 10F associated with that POS system. The POS data interceptor 10F transmits via the data transmitter 30 (and via a suitable data network) in real time the draw game wager request data to the lottery central system 750.

In various embodiments, the bet details indicate a customer's selected numbers, a selected lottery game type, any selected draw dates, any selected optional features, and/or other suitable information associated with the draw lottery ticket. In some embodiments, the bet details include quick pick numbers that the mobile application of the player electronic device randomly selected, or a quick pick indication for a random selection of the quick pick numbers (e.g., by the lottery central system 750, by the POS data interceptor 10F, or by another suitable entity). In some embodiments, the bet details include player identification information that is employable to identify the customer.

The lottery central system 750 processes the draw game wager request data and creates in real time draw game wager response data. The lottery central system 750 sends in real time the draw game wager response data to the POS data interceptor 10F. The draw game wager response data can either include a wager confirmation or a wager denial. In various embodiments for a wager confirmation, the lottery central system 750 generates the draw game wager response data to include: (1) a lottery product identifier associated with the draw lottery ticket (e.g., a PLU); and (2) a lottery ticket value identifier associated with the draw lottery ticket (e.g., a purchase price). In certain embodiments, the lottery central system 750 generates the draw game wager response data to additionally include current information associated with the draw lottery ticket (e.g., a current jackpot value or other suitable information).

In various embodiments, the lottery central system 750 selects the lottery product identifier (e.g., PLU) based on the draw game wager request data (e.g., based on the selected lottery game type, any selected draw dates, any selected optional features, any applicable draw lottery ticket promotions, and/or other suitable information associated with the draw lottery ticket). In some embodiments, the lottery central system 750 employs the retailer identifier of the draw game wager request data to select the lottery product identifier (e.g., by selecting the lottery product identifier from lottery product identifiers that are associated with that retailer identifier). In some embodiments, the lottery central system 750 employs a network address and/or device identifier (e.g., an IP address, MAC address, or IMEI) associated with the POS data interceptor 10F to select the lottery product identifier (e.g., by selecting the lottery product identifier from lottery product identifiers that are associated with the POS data interceptor 10F having that network address and/or device identifier).

In various embodiments, the lottery ticket value identifier indicates a purchase price associated with the draw lottery ticket and set by a lottery system operator. In some embodiments, the lottery ticket value identifier includes the purchase price itself, such as a value of $2, $5, or $10. In some embodiments, the lottery ticket value identifier includes an index to a set of predetermined purchase prices (e.g., an index of 0, 1, or 2 indicates a purchase price of $2, $5, or $10, respectively).

In various embodiments, the lottery ticket value identifier enables increased variability in purchase prices for different lottery tickets having a same lottery game type. In some embodiments, the lottery ticket value identifier enables different purchase prices for draw lottery tickets of a particular lottery game type based on whether optional features associated with that lottery game type have been selected (e.g., an optional multiplier for non-jackpot winnings with an additional cost of $1.00 when selected). In some embodiments, the lottery ticket value identifier enables different purchase prices for draw lottery tickets of a particular lottery game type based on whether a draw lottery ticket promotion is currently available (e.g., a discounted price, a free or discounted optional feature, a free or discounted additional draw date, a free or discounted additional set of player numbers). In some embodiments, the lottery ticket value identifier enables an automated price lookup of purchase prices set by the lottery system operator and more efficient processing at checkout without needing to look up or manually enter the purchase prices.

The lottery central system 750 determines the lottery ticket value identifier based on the draw game wager request data and/or bet details (e.g., based on the selected lottery game type, any selected draw dates, and/or any selected optional features for the draw lottery ticket). In some embodiments, different draw lottery tickets for the same lottery game type are associated with different lottery ticket value identifiers based on whether optional features associated with that lottery game type have been selected. As an example, a draw lottery ticket can have a base price of $4 with no optional features being selected, an increased price of $5 with one optional feature being selected, and an increased price of $6 with two optional features being selected.

Responsive to receiving the draw game wager response data, the POS data interceptor 10F determines in real time if the draw game wager response data includes a wager confirmation or a wager denial. In some embodiments, if the draw game wager response data includes a wager denial, the POS data interceptor 10F does not provide any product code to the POS system terminal 710. In some embodiments, if the draw game wager response data includes a wager denial, the POS data interceptor 10F displays a suitable error code or indication via the display device 70 or other status indicator. In some embodiments, if the draw game wager response data includes a wager denial, the POS data interceptor 10F sends suitable error code data to the POS system terminal 710 for enabling the POS system terminal 710 to cause a display such that an operator can indicate the error or issue to address such error or issue in a suitable manner.

If the draw game wager response data includes a wager confirmation, the POS data interceptor 10F generates in real time a product code that indicates the lottery product identifier (e.g., PLU) and the lottery ticket value identifier (e.g., included and/or encoded within the product code) for the purchase of the draw lottery ticket. In some embodiments, the product code additionally indicates an error check identifier and/or other suitable lottery ticket information (e.g., a lottery game type or game identifier, a site identifier, a lottery ticket type, an instant lottery ticket pack identifier, an instant lottery ticket number, an instant ticket inventory control number). The error check identifier enables error detection for the product code. In some other embodiments for a wager confirmation, the lottery central system 750 generates the product code and generates the draw game wager response data to include the product code.

In various embodiments, the product code is encodable into a 1-dimensional barcode format, a 2-dimensional barcode (e.g., matrix code or QR code), or other suitable machine-readable format. In some embodiments, the product code includes a universal product code (UPC), such as a UPC-A of Type 4 that is reserved for store use. In some embodiments, the product code includes a European Article Number, such as an EAN-13 having a GS1 prefix from 020 to 029 that is reserved for retailer internal use. In some embodiments, the product code includes a global trade item number (GTIN) or other suitable product code. In some embodiments, the product code is encodable into an i2of5 barcode. It will be appreciated that such product codes (e.g., UPCs) and lottery product identifiers (e.g., PLUs) enable more detailed tracking for purchases of lottery tickets specific to a particular POS system for a retail store or chain.

In this example embodiment, the product code includes a UPC-A of Type 4 that includes the selected lottery product identifier (i.e., the PLU), the selected lottery ticket value identifier (i.e., the purchase price), and a UPC-A check digit as the error check identifier.

The POS data interceptor 10F sends the product code for this draw lottery ticket to the POS system terminal 710. In various embodiments, the POS system terminal 710 employs the product code to add a lottery ticket purchase for the draw lottery ticket to a POS shopping cart created for the customer (e.g., adding a debit line item for the purchase price to a POS transaction). The operator of the POS system terminal 710 obtains payment for all items in the POS shopping cart for the customer and provides a suitable receipt. In some embodiments, the POS data interceptor 10F causes the lottery system printer 780 to print the draw lottery ticket (or draw lottery ticket receipt) and the operator of the POS system terminal 710 provides the printed draw lottery ticket to the customer. In some embodiments, the system 700 provides a digital draw lottery ticket to the customer for the purchase. In some embodiments, the POS data interceptor 10F causes the lottery system printer 780 to print the draw lottery ticket with additional information, such as ticket messaging information (e.g., included in the wager response) and/or player identification information (e.g., included in the bet details).

In this example embodiment, if the scan data received by the POS data interceptor 10F from the POS system scanner 715 does not include lottery ticket related data, the POS data interceptor 10F relays or otherwise transmits that scan data to the POS system terminal 710, and the POS system terminal 710 processes that scan data in a conventional manner.

In various embodiments, the POS data interceptor 10F or the lottery central system 750 can determine the symbols (such as the player numbers) for the draw lottery ticket. For example, the player numbers for a play of a quick pick draw lottery ticket can be determined by the lottery central system 750 and can be part of the wager confirmation. The POS data interceptor 10F can cause the draw lottery ticket with these numbers to be printed on the connected lottery system printer 780.

In various embodiments, instead of the draw lottery ticket play slip T7, the operator of the POS system scanner 715 scans a ticket barcode and/or ticket identifier associated with a previously purchased draw lottery ticket. For example, the customer can present a printed (or digital) draw lottery ticket or draw lottery ticket receipt to request a new purchase based on bet details for the previously purchased draw lottery ticket. In these embodiments, responsive to receiving lottery ticket related data (including scanned draw lottery ticket identifier data), the POS data interceptor 10F decodes the lottery ticket related data to obtain the ticket identifier for the previously purchased draw lottery ticket and creates in real time the draw game wager request data based thereon. The lottery central system 750 can determine the bet details based on the ticket identifier, then determine the lottery product identifier and the lottery ticket value identifier as described above.

In various embodiments, instead of the draw lottery ticket play slip T7, the operator of the POS system scanner 715 scans a scratch off instant lottery ticket requested for purchase by the customer or a corresponding static product code on a pre-printed instant lottery ticket price sheet, such as the pre-printed instant lottery ticket price sheet T6. The scratch off instant lottery ticket can include a ticket barcode representing an inventory control number of that instant lottery ticket and/or a static product barcode representing the static product code. The static product code can be associated with any instant lottery tickets associated with a same instant game type and is different from the inventory control number that uniquely identifies a particular instant lottery ticket.

In various embodiments, the POS data interceptor 10F parses the scan data from the POS system scanner 715 to determine if the static product code associated with an instant lottery ticket has been scanned (e.g., from the instant lottery ticket or pre-printed instant lottery ticket price sheet). For example, the POS data interceptor 10F parses a company code of a scanned UPC barcode and determines that a static UPC associated with an instant lottery ticket has been scanned when the parsed company code is associated with the lottery system operator. In these embodiments, the POS data interceptor 10F blocks the static product code from being transmitted to the POS system terminal 710 and creates in real time instant ticket activation request data based on the static product code.

In these embodiments, the POS data interceptor 10F sends the instant ticket activation request data to the lottery central system 750 for activation of the instant lottery ticket. The lottery central system 750 determines a lottery product identifier (e.g., PLU) and a lottery ticket value identifier for the instant lottery ticket, creates instant ticket activation response data including the lottery product identifier and the lottery ticket value identifier, and sends the instant ticket activation response data to the POS data interceptor 10F. Based on the lottery product identifier (e.g., PLU) and the lottery ticket value identifier from the instant ticket activation response data, the POS data interceptor 10F generates the product code (e.g., UPC), as indicated above.

In these embodiments, a purchase price associated with the static product code is different from a purchase price associated with the real time generated product code. For example, the purchase price associated with the real time generated product code can be less than the purchase price associated with the static product code (e.g., based on a lottery ticket promotion). In these embodiments, the system 700 enables the use of a limited quantity of licensed, static product codes on instant lottery tickets to: (1) maintain compatibility of those instant lottery tickets with POS systems that are not connected to the POS data interceptor 10F; and/or (2) enable a backup purchase procedure using the POS data interceptor 10F when lottery product identifiers and/or lottery ticket value indicators are currently unavailable (e.g., due to connection issues with the lottery central system 750).

In these embodiments, the POS data interceptor 10F converts a first, static product code printed on an instant lottery ticket (or pre-printed instant lottery ticket price sheet) into a second, real time generated product code that is specific to the purchase of that instant lottery ticket having a particular purchase price (e.g., based on optional features associated with that lottery ticket and/or applicable lottery ticket promotions) and specific to a POS system or retail store at which the purchase was made. The system 700 thus enables a conversion of a general product code (i.e., the static UPC) associated with a general purchase price (i.e., a static purchase price stored in the POS system) into a variable product code associated with a variable purchase price.

In various embodiments, the POS data interceptor 10F parses the scan data from the POS system scanner 715 to determine if the inventory control number (or associated barcode) printed on an instant lottery ticket has been scanned. The POS system terminal 710 alone cannot process the inventory control number to obtain a purchase price for the instant lottery ticket, as indicated above. In these embodiments, the POS data interceptor 10F creates in real time instant ticket activation request data based on the inventory control number and sends the instant ticket activation request data to the lottery central system 750 for activation of the instant lottery ticket. The lottery central system 750 determines a lottery product identifier (e.g., PLU) and a lottery ticket value identifier for the instant lottery ticket based on the inventory control number, creates instant ticket activation response data including the lottery product identifier and the lottery ticket value identifier, and sends the instant ticket activation response data to the POS data interceptor 10F. Based on the lottery product identifier (e.g., PLU) and the lottery ticket value identifier from the instant ticket activation response data, the POS data interceptor 10F generates the product code (e.g., UPC), as indicated above.

In these embodiments, the POS data interceptor 10F converts a first, unique inventory control number printed on an instant lottery ticket into a second, real time generated product code that is specific to the purchase of that instant lottery ticket having a particular purchase price (e.g., based on optional features associated with that lottery ticket and/or applicable lottery ticket promotions) and specific to a POS system or retail store at which the purchase was made. The system 700 thus enables a conversion of a unique inventory control number, which the POS system terminal 710 alone cannot process to obtain purchase price information, into a variable product code associated with a variable purchase price.

In various embodiments, instead of employing the lottery product identifier (such as a PLU number) to generate a product code (such as a UPC), the system 700 employs lottery product identifiers that include product codes. In these embodiments, the lottery central system 750 stores different product codes (e.g., UPCs), selects a product code for a lottery ticket based on the draw game wager request data, and generates the wager response data to include the selected product code. In these embodiments, the POS data interceptor 10F sends the product code from the wager response data to the POS system terminal 710.

In some embodiments, the lottery central system 750 stores different product codes for each lottery game type and each purchase price for lottery tickets of those lottery game types. In these embodiments, each product code is associated with a single game type and a single purchase price. In some embodiments, the lottery central system 750 stores a product code for each lottery game type that enables a variable purchase price for lottery tickets of that lottery game type. In these embodiments, the POS data interceptor 10F causes the purchase price to be provided to the operator of the POS system terminal 710 for manual entry into the POS system terminal 710 (e.g., by causing the lottery system printer 780 to print the purchase price and/or displaying the purchase price via its display device 70). In some embodiments, the lottery central system 750 stores different product codes for different lottery game types and purchase prices and product codes for lottery game types that enable variable purchase prices.

In various embodiments, the POS data interceptor 10F provides visual and/or audio feedback for certain operations of the POS data interceptor 10F, such as a successful scan of a play slip or other lottery ticket information provider, an unsuccessful scan of a play slip or other lottery ticket information provider, a connection error, or other suitable feedback. In some embodiments, the POS data interceptor 10F provides visual feedback via its display device 70. In some embodiments, the POS data interceptor 10F includes and provides the visual feedback via a plurality of LEDs.

In various other embodiments, the POS data interceptor 10F is configured with an additional interceptor scanner (not shown). In these other embodiments, the operator employs the additional interceptor scanner alternatively to the POS system scanner 715 for the purchase of a lottery ticket.

### Seventh Example Implementation of Interceptor

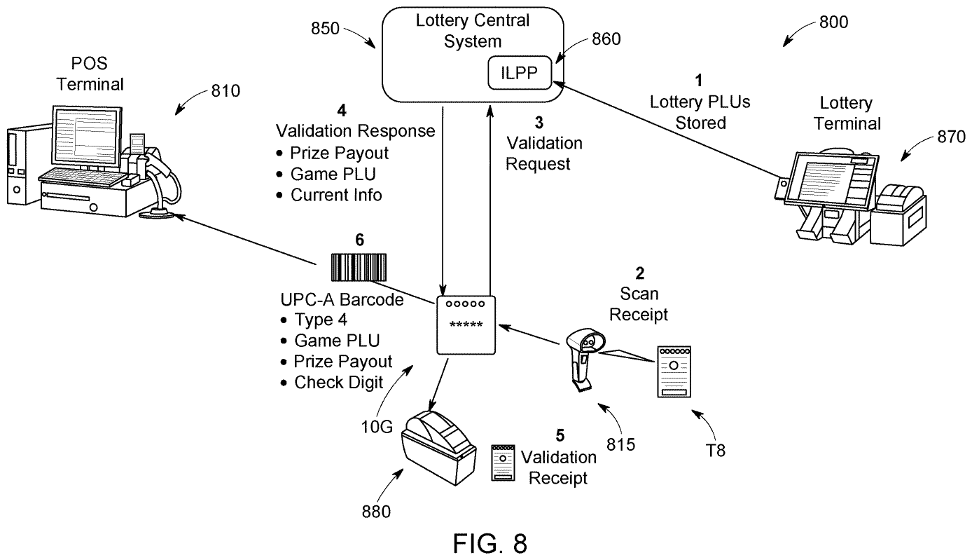

FIG. 8 illustrates a system 800 (and related method) employing a POS data interceptor 10G with a lottery central system 850, a POS system scanner 815, a POS system terminal 810, a lottery terminal 870, and a lottery system printer 880 in accordance with a seventh example embodiment of the present disclosure. In various embodiments, the system 800 employs a lottery product identifier (e.g., PLU) and a lottery ticket value identifier to enable generation in real time of a product code (e.g., UPC) that is specific to a redemption of a lottery ticket (e.g., a draw lottery ticket and/or instant lottery ticket) associated with a particular payout amount and specific to a POS system or retail store at which the redemption was made. In some embodiments, the system 800 employs the lottery product identifier and the lottery ticket value identifier to avoid the use of a limited quantity of licensed, static product codes. In some embodiments, the system 800 employs the lottery product identifier and the lottery ticket value identifier to enable a plurality of real time generated product codes in addition to a limited quantity of licensed, static product codes.

In this example embodiment, the lottery ticket information provider is a draw lottery ticket receipt T8 and the system 800 facilitates redemption of lottery tickets having variable payout amounts based on the draw lottery ticket receipt T8.

The lottery central system 850 includes: (1) a housing; (2) a lottery terminal connector 860; (3) a data transmitter; (4) a data receiver; (5) a processor; and (6) a memory device. In this example embodiment, the lottery terminal connector 860 includes an in-lane proxy product (ILPP) that enables communication with the lottery terminal 870 via a suitable application programming interface (API), such as a NASPL API. In other embodiments, the lottery terminal connector 860 includes another suitable communication interface.

The lottery terminal 870 includes: (1) a housing; (2) a lottery central system connector; (3) a display device (which can include a touch-screen input device); (4) a data transmitter; (5) a data receiver; (6) a processor; and (7) a memory device. In various embodiments, the lottery terminal 870 additionally includes a printer connector. In this example embodiment, the lottery central system connector enables communication with the lottery central system 850 via the NASPL API. In other embodiments, the lottery terminal 870 employs a different suitable communication interface. In this example embodiment, the lottery terminal 870 is located at a retail location of the POS system terminal 810. In other embodiments, the lottery terminal 870 is located at a retail management location (e.g., a management office of a retail chain associated with the POS system terminal 810).

In operation of this example embodiment, an operator of the lottery terminal 870, such as a retail chain manager associated with the POS system, inputs or modifies lottery product identifiers (e.g., PLUs) associated with lottery tickets that are available for redemption from the POS system terminal 810.

In a similar manner as indicated above, the lottery terminal 870 sends the lottery product identifiers (e.g., PLUs) and/or modifications to the lottery central system 850.

In various embodiments, the lottery product identifiers (e.g., PLU) are employable to identify lottery ticket transactions, such as purchases and/or redemptions, for certain lottery tickets, such as winning lottery tickets associated with different lottery game types, non-winning tiers and/or winning tiers, different payout amounts, and/or other suitable variations in lottery tickets.

In various embodiments, the lottery product identifiers include in-store product identifiers that can vary from retail chain to retail chain or from retail store to retail store. In these embodiments, certain lottery product identifiers can be specific to a POS system, retail store, or retail chain. In various embodiments, the lottery product identifiers include price look-up (PLU) numbers, stock keeping unit (SKU) numbers, or other suitable product identifiers. It should be appreciated that different retail chains, retail stores, and/or POS systems can employ different lottery product identifiers for otherwise identical lottery tickets (i.e., a winning ticket can be associated with different PLUs or SKUs when redeemed from different retail stores).

In this example embodiment, each lottery product identifier includes a price look-up (PLU) number. Specifically, the lottery product identifier includes a 4-digit or 5-digit retailer assigned PLU code (for example, PLU codes 3170 to 3270) and each PLU indicates lottery tickets of a particular lottery game type, non-winning and/or winning tier, different payout amounts, and/or other suitable variations in lottery tickets. As an example, a lottery product identifier of “3250” can indicate winning lottery tickets for a first instant lottery game type and a lottery product identifier of “3251” can indicate winning lottery tickets for a second instant lottery game type, and a lottery product identifier of “3252” can indicate winning lottery tickets for a first draw lottery game type. As another example, a lottery product identifier of “3260” can indicate non-winning instant lottery tickets for the first instant lottery game type, a lottery product identifier of “3261” can indicate low-tier winning lottery tickets for the first instant lottery game type, and a lottery product identifier of “3262” can indicate mid-tier winning lottery tickets for the first instant lottery game type.

The lottery central system 850 stores the lottery product identifiers (e.g., PLUs) for subsequent lottery ticket redemptions from that POS system. In some embodiments, the lottery central system 850 stores a retailer identifier that identifies the POS data interceptor 10G associated with that POS system. The retailer identifier enables a lookup of lottery product identifiers that are specific to a POS system.

For a redemption of a lottery ticket, an operator of the POS system scanner 815 scans the draw lottery ticket receipt T8 that a customer has presented for a redemption of a lottery ticket. In some other embodiments, the operator employs a dedicated lottery ticket scanner connected to the POS data interceptor 10G to scan the draw lottery ticket receipt T8. In this embodiment, the draw lottery ticket receipt T8 includes a printed draw lottery ticket receipt that includes a draw lottery ticket identifier associated with a previously purchased draw lottery ticket. In some other embodiments, the customer can present a digital draw lottery ticket receipt that is displayed by a display device of a player electronic device with a mobile application (not shown) downloaded thereon. In some other embodiments, the customer can present a previously purchased scratch off instant lottery ticket (i.e., with SOC removed to reveal a validation code) to be scanned. In some other embodiments, the customer can present a revealed digital instant lottery receipt that is displayed by a display device of a player electronic device with a mobile application (not shown) downloaded thereon.

The POS data interceptor 10G monitors the scan data from scans by the POS system scanner 815 and reacts if lottery ticket related data is received from the POS system scanner 815. Specifically, responsive to receiving lottery ticket related data (including scanned draw lottery ticket identifier data associated with this receipt or scanned validation code data associated with an instant lottery ticket), the POS data interceptor 10G decodes the lottery ticket related data to obtain the draw lottery ticket identifier (or validation code) for the redemption of the lottery ticket and creates in real time ticket validation request data based thereon. The POS data interceptor 10G transmits via the data transmitter 30 (and via a suitable data network) in real time the ticket validation request data to the lottery central system 850.

The lottery central system 850 processes the ticket validation request data and creates in real time ticket validation response data. The lottery central system 850 sends in real time the ticket validation response data to the POS data interceptor 10G. The ticket validation response data can either include a validation confirmation or a validation denial. In various embodiments for a validation confirmation, the lottery central system 850 generates the ticket validation response data to include: (1) a lottery product identifier (e.g., PLU) associated with the lottery ticket; and (2) a lottery ticket value identifier associated with the lottery ticket. In certain embodiments, the lottery central system 850 generates the ticket validation response data to additionally include current information associated with the lottery ticket. In certain embodiments, the lottery central system 850 generates the ticket validation response data to additionally include a winning tier indicator associated with the lottery ticket, such as: (1) no win indicator, (2) low-tier win indicator, (3) mid-tier win indicator, and (4) high-tier win indicator.

In various embodiments, the lottery central system 850 selects the lottery product identifier (e.g., PLU) based on the ticket validation request data (e.g., based on the draw lottery ticket identifier, validation code, and/or other suitable information associated with the lottery ticket). In some embodiments, the lottery central system 850 selects the lottery product identifier based on a payout amount or tier associated with the lottery ticket. In some embodiments, the lottery central system 850 employs the retailer identifier of the ticket validation request data to select the lottery product identifier (e.g., by selecting the lottery product identifier from lottery product identifiers that are associated with that retailer identifier). In some embodiments, the lottery central system 850 employs a network address and/or device identifier (e.g., an IP address, MAC address, or IMEI) associated with the POS data interceptor 10G to select the lottery product identifier (e.g., by selecting the lottery product identifier from lottery product identifiers that are associated with the POS data interceptor 10G having that network address and/or device identifier).

In various embodiments, the lottery ticket value identifier indicates a payout amount associated with the lottery ticket. In some embodiments, the lottery ticket value identifier includes the payout amount, such as a value of $10, $50, or $100. In some embodiments, the lottery ticket value identifier includes an index to a set of predetermined payout amounts (e.g., an index of 0, 1, or 2 indicates a payout amount of $10, $50, or $100, respectively).

In various embodiments, the lottery ticket value identifier enables increased variability in payout amounts for different lottery tickets. In some embodiments, the lottery ticket value identifier allows for automated payout amount lookup and more efficient processing at checkout without needing to look up or manually enter the payout amount.

The lottery central system 850 determines the lottery ticket value identifier based on the ticket validation request data (e.g., based on the draw lottery ticket identifier or validation code). For example, the lottery central system 850 performs a lookup of the validation code of an instant lottery ticket to determine the payout amount associated with that instant lottery ticket and determines the lottery ticket value identifier based on the payout amount.

Responsive to receiving the ticket validation response data, the POS data interceptor 10G determines in real time if the ticket validation response data includes a validation confirmation or a validation denial. If the ticket validation response data includes a validation denial, the POS data interceptor 10G sends suitable code data to the POS system terminal 810 for enabling the POS system terminal 810 to cause a display such that an operator can indicate the denial in a suitable manner (e.g., indicating that the lottery ticket is not a winning lottery ticket).

If the ticket validation response data includes a validation confirmation, the POS data interceptor 10G generates in real time a product code (e.g., UPC) that indicates the lottery product identifier (e.g., PLU) and the lottery ticket value identifier (e.g., included and/or encoded within the product code) for the redemption of the lottery ticket. In some embodiments, the product code additionally indicates an error check identifier and/or other suitable lottery ticket information. The error check identifier enables error detection for the product code. In some other embodiments for a validation confirmation, the lottery central system 850 generates the product code and generates the ticket validation response data to include the product code.

The POS data interceptor 10G sends the product code for this lottery ticket to the POS system terminal 810. In various embodiments for a low-tier win indicator and/or mid-tier win indicator, the POS system terminal 810 employs the product code to add a lottery ticket redemption for the lottery ticket to a POS shopping cart created for the customer (e.g., adding a credit line item for the payout amount to a POS transaction). The operator of the POS system terminal 810 provides payment to the customer based on the credit for the payout amount or obtains a payment for any other purchased items in the POS shopping cart (reduced by the credit for the payout amount) for the customer and provides a suitable receipt. In some embodiments, the POS data interceptor 10G causes the lottery system printer 880 to print a ticket validation receipt and the operator of the POS system terminal 810 provides the printed ticket validation receipt to the customer. In some embodiments, the system 800 provides a digital validation receipt to the customer.

In various embodiments, the mid-tier win indicator can require approval by more than one operator. The receipt can be part of a separate shopping checkout receipt (such as a receipt printed at checkout on the POS system).

Responsive to the product code including a high-tier win indicator, the POS system terminal 810 can provide a printed receipt that includes instructions for the customer for obtaining the high-tier payout. In other embodiments, such instructions can be separately provided to the customer.

In this example embodiment, if the scan data received by the POS data interceptor 10G from the POS system scanner 815 does not include lottery ticket related data, the POS data interceptor 10G relays or otherwise transmits that scan data to the POS system terminal 810, and the POS system terminal 810 processes that scan data in a conventional manner.

In various embodiments, the POS data interceptor 10G provides visual and/or audio feedback for certain operations of the POS data interceptor 10G, such as a successful scan of a lottery ticket receipt, an unsuccessful scan of a lottery ticket receipt, a connection error, or other suitable feedback. In some embodiments, the POS data interceptor 10G provides visual feedback via its display device 70. In some embodiments, the POS data interceptor 10G includes and provides the visual feedback via a plurality of LEDs.

In various other embodiments, the POS data interceptor 10G is configured with an additional interceptor scanner (not shown). In these other embodiments, the operator employs the additional interceptor scanner alternatively to the POS system scanner 815 for the redemption of lottery tickets.

### Eighth Example Implementation of Interceptor

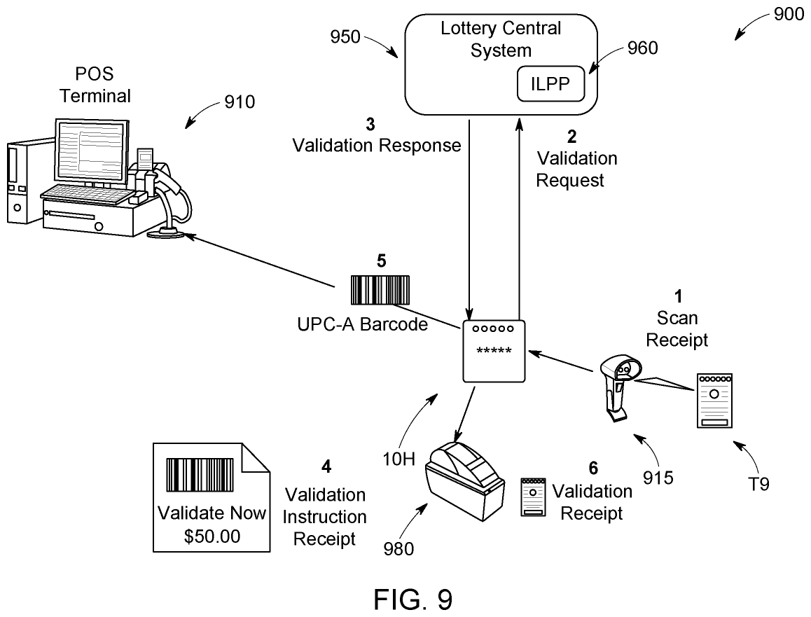

FIG. 9 illustrates a system 900 (and related method) employing a POS data interceptor 10H with a lottery central system 950, a POS system scanner 915, a POS system terminal 910, and a lottery system printer 980 in accordance with an eighth example embodiment of the present disclosure. In various embodiments, the system 900 employs a validation product code (e.g., UPC or EAN) and a lottery ticket value identifier to enable a redemption of a winning lottery ticket (e.g., a draw lottery ticket and/or instant lottery ticket) associated with a particular payout amount (e.g., a UPC or EAN configured for crediting a variable amount). In some embodiments, the system 900 employs a same validation product code for different payout amounts for winning tickets of a same lottery game. In some embodiments, the system 900 employs a same validation product code for different payout amounts of multiple, different lottery games (e.g., draw lottery games and/or instant lottery games). In some embodiments, the system 900 employs a same validation product code for redemptions at all retailers within a jurisdiction for multiple, different lottery games.

In this example embodiment, the lottery ticket information provider is a draw lottery ticket receipt T9 and the system 900 facilitates redemption of lottery tickets having variable payout amounts based on the draw lottery ticket receipt T9.

The lottery central system 950 includes: (1) a housing; (2) a lottery terminal connector 960; (3) a data transmitter; (4) a data receiver; (5) a processor; and (6) a memory device. In this example embodiment, the lottery terminal connector 960 includes an in-lane proxy product (ILPP) that enables communication with the lottery terminal 970 via a suitable lottery application programming interface (API), such as a NASPL API. In other embodiments, the lottery terminal connector 960 includes another suitable communication interface.

In some embodiments, the lottery central system 950 stores a validation product code (e.g., a UPC) for lottery ticket redemptions. In some embodiments, the POS data interceptor 10H stores a validation product code for lottery ticket redemptions.

For a redemption of a lottery ticket, an operator of the POS system scanner 915 scans the draw lottery ticket receipt T9 that a customer has presented for a redemption of a lottery ticket. In some other embodiments, the operator employs a dedicated lottery ticket scanner connected to the POS data interceptor 10H to scan the draw lottery ticket receipt T9. In this embodiment, the draw lottery ticket receipt T9 includes a printed draw lottery ticket receipt that includes a draw lottery ticket identifier associated with a previously purchased draw lottery ticket. In some other embodiments, the customer can present a digital draw lottery ticket receipt that is displayed by a display device of a player electronic device with a mobile application (not shown) downloaded thereon. In some other embodiments, the customer can present a previously purchased scratch off instant lottery ticket (i.e., with SOC removed to reveal a validation code) to be scanned. In some other embodiments, the customer can present a revealed digital instant lottery receipt that is displayed by a display device of a player electronic device with a mobile application (not shown) downloaded thereon.

The POS data interceptor 10H monitors the scan data from scans by the POS system scanner 915 and reacts if lottery ticket related data is received from the POS system scanner 915. Specifically, responsive to receiving lottery ticket related data (including scanned draw lottery ticket identifier data associated with this receipt, scanned validation code data associated with an instant lottery ticket), the POS data interceptor 10H decodes the lottery ticket related data to obtain the draw lottery ticket identifier (or validation code) for the redemption of the lottery ticket and creates in real time ticket validation request data based thereon. The POS data interceptor 10H transmits via the data transmitter 30 (and via a suitable data network) in real time the ticket validation request data to the lottery central system 950.

The lottery central system 950 processes the ticket validation request data and creates in real time ticket validation response data. The lottery central system 950 sends in real time the ticket validation response data to the POS data interceptor 10H. The ticket validation response data can either include a validation confirmation or a validation denial.

In various embodiments for a validation denial, lottery central system 950 generates the ticket validation response data to include non-winning ticket receipt data, such as an indication that the lottery ticket is not a winning lottery ticket.

In various embodiments for a validation confirmation, such as for a high-tier payout (e.g., greater than $600.00), the lottery central system 950 generates the ticket validation response data to include high-tier ticket receipt data, such as instructions for how the customer can claim the high-tier payout for the winning lottery ticket.

In various embodiments for a validation confirmation, such as for a low-tier payout or mid-tier payout (e.g., $600.00 or less), the lottery central system 950 generates the ticket validation response data to include: (1) a validation product code (e.g., UPC) associated with the lottery ticket; and (2) a lottery ticket value identifier associated with the lottery ticket. In some embodiments, the lottery central system 950 generates the ticket validation response data to additionally include current information associated with the lottery ticket. In some embodiments, the lottery central system 950 generates the ticket validation response data without the validation product code (e.g., when the POS data interceptor 10H stores the validation product code).

In various embodiments for a validation confirmation, the lottery central system 950 selects the validation product code (e.g., UPC) based on the ticket validation request data (e.g., based on the draw lottery ticket identifier, lottery game type, validation code, and/or other suitable information associated with the lottery ticket). In some embodiments, the lottery central system 950 selects the validation product code based on a jurisdiction associated with the lottery ticket.

In various embodiments for a validation confirmation, the lottery ticket value identifier indicates a payout amount associated with the lottery ticket, as described above.

Responsive to receiving the ticket validation response data, the POS data interceptor 10H determines in real time if the ticket validation response data includes a validation confirmation or a validation denial. In some embodiments, if the ticket validation response data includes a validation denial, the POS data interceptor 10H causes the lottery system printer 980 to print a non-winning ticket receipt (e.g., indicating that the lottery ticket is not a winning lottery ticket).

In various embodiments, if the ticket validation response data includes validation confirmation, the POS data interceptor 10H causes the lottery system printer 980 to print a validation instruction receipt for the winning lottery ticket. In various embodiments, such as for a high-tier payout (e.g., greater than $600.00), the validation instruction receipt includes instructions for how the customer can claim the high-tier payout for the winning lottery ticket. In other embodiments, such instructions can be separately provided to the customer.

In various embodiments, such as for a low-tier payout or mid-tier payout, the validation instruction receipt includes the validation product code as a printed barcode (e.g., UPC) associated with the winning lottery ticket and the printed payout amount associated with the winning lottery ticket (e.g., based on the lottery ticket value identifier). In this embodiment, the validation instruction receipt includes an instruction indicating that the winning lottery ticket can be validated via the POS terminal 910 (“Validate Now”), the validation product code as a printed barcode (e.g., UPC), and the payout amount for the winning lottery ticket (“$50.00”).

In various embodiments, the operator of the POS system scanner 915 scans the validation product code (e.g., UPC) on the validation instruction receipt. In some other embodiments, the operator employs a dedicated lottery ticket scanner connected to the POS data interceptor 10H to scan the validation product code. The POS data interceptor 10H sends scanned validation product code data for the lottery ticket to the POS system terminal 910.

In various embodiments for a low-tier win indicator and/or mid-tier win indicator, the POS system terminal 910 employs the scanned validation product code data to add a lottery ticket redemption for the lottery ticket to a POS shopping cart created for the customer. In some embodiments, the operator of the POS system terminal 910 manually enters the payout amount from the validation instruction receipt via a credit pop-up modal (e.g., adding a credit line item for the payout amount to a POS transaction). The operator of the POS system terminal 910 provides payment to the customer based on the credit for the payout amount or obtains a payment for any other purchased items in the POS shopping cart (reduced by the credit for the payout amount) for the customer and provides a suitable receipt. In some embodiments, the POS data interceptor 10H causes the lottery system printer 980 to print a ticket validation receipt and the operator of the POS system terminal 910 provides the printed ticket validation receipt to the customer. In some embodiments, the system 900 provides a digital validation receipt to the customer. In some embodiments, the POS data interceptor 10H causes the lottery system printer 980 to print a separate ticket validation receipt to be held by the retailer.

In various embodiments, the mid-tier win indicator can require approval by more than one operator.

In various embodiments, the POS data interceptor 10H provides visual and/or audio feedback for certain operations of the POS data interceptor 10H, such as a successful scan of a lottery ticket receipt, an unsuccessful scan of a lottery ticket receipt, a successful scan of a validation instruction receipt, an unsuccessful scan of a validation instruction receipt, receipt of a validation denial, receipt of a validation confirmation, a connection error, or other suitable feedback. In some embodiments, the POS data interceptor 10H provides visual feedback via its display device 70. In some embodiments, the POS data interceptor 10H includes and provides the visual feedback via a plurality of LEDs.

In various other embodiments, the POS data interceptor 10H is configured with an additional interceptor scanner (not shown). In these other embodiments, the operator employs the additional interceptor scanner alternatively to the POS system scanner 915 for the redemption of lottery tickets.

### Customer As Operator

In various embodiments, the customer can function as the operator of the POS system where the POS system is configured for self-check-out by the customer. In various such embodiments, certain of the actions described above that are taken by the operator would be taken by the customer to effectuate the purchase of one or more lottery tickets. Such actions can include the scanning actions and the receipt of payment actions (such as via a credit or debit card) as described above. In some embodiments, the customer causes their electronic smartphone (or other player electronic device) to display a digital play slip and employs the POS system scanner (or dedicated interceptor scanner) to scan the digital play slip as described above.

It should be appreciated from the above that various embodiments of the present disclosure provide a point-of-sale (POS) data interceptor communicatively and operably connectable to a POS system comprising a POS system scanner that comprises a POS scanner housing and a POS system terminal that comprises a POS terminal housing. The POS data interceptor comprises: (1) an interceptor housing that is separate from the POS scanner housing and the POS terminal housing; (2) a POS scanner connector supported by the interceptor housing and communicatively connectable to the POS system scanner such that the POS data interceptor is connected to the POS system scanner in place of the POS system terminal; (3) a terminal connector supported by the interceptor housing and communicatively connectable to the POS system terminal such that the POS data interceptor is connected to the POS system terminal in place of the POS system scanner; (4) a data transmitter supported by the interceptor housing; (5) a data receiver supported by the interceptor housing; (6) a processor supported by the interceptor housing and communicatively connected to the POS scanner connector, the terminal connector, the data transmitter, and the data receiver; and (7) a memory device supported by the interceptor housing. The memory device stores a plurality of instructions that when executed by the processor, cause the POS data interceptor to: monitor all scan data received from the POS system scanner based on all scans by the POS system scanner; responsive to receiving scan data that comprises lottery ticket related data that is related to a purchase of a lottery ticket: generate and send a lottery ticket purchase request for the purchase of the lottery ticket based on the lottery ticket related data to a lottery central system, receive from the lottery central system a lottery ticket purchase response comprising a product identifier for the lottery ticket based on the lottery ticket purchase request, and determine and cause transmittal of a product code for the purchase of the lottery ticket to the POS system terminal based on the product identifier; and responsive to receiving scan data from the POS system scanner that does not comprise any lottery ticket related data, cause transmittal of said scan data without modification to the POS system terminal. In various such embodiments, the product identifier is stored by the lottery central system for lottery ticket purchases specific to the POS system, the product identifier comprises a retailer assigned product lookup code, the product code comprises a universal product code, the lottery ticket purchase response comprises a value identifier for the lottery ticket that is based on the lottery ticket purchase request, and the universal product code indicates a purchase value for the purchase of the lottery ticket based on the value identifier. In various such embodiments, the product identifier comprises a universal product code that indicates a purchase value for the purchase of the lottery ticket. In various such embodiments, the lottery ticket comprises a draw lottery ticket, the lottery ticket purchase request comprises a draw wager request for the purchase of the draw lottery ticket, the lottery ticket purchase response comprises a value identifier for the draw lottery ticket that is based on the lottery ticket purchase request, the product code indicates a purchase value for the purchase of the draw lottery ticket based on the value identifier, and the value identifier indicates a debit amount for the purchase of the draw lottery ticket. In various such embodiments, the scan data is based on a scan of a digital play slip displayed by a player electronic device, the digital play slip comprises a QR code that indicates bet details for the purchase of the draw lottery ticket, the draw wager request comprises the bet details, and the product identifier and the value identifier are based on the bet details for the purchase of the draw lottery ticket. In various such embodiments, the lottery ticket comprises an instant lottery ticket, the lottery ticket purchase request comprises an activation request for the purchase of the instant lottery ticket, the lottery ticket purchase response comprises a value identifier for the instant lottery ticket that is based on the lottery ticket purchase request, the product code indicates a purchase value for the purchase of the instant lottery ticket based on the value identifier, and the value identifier indicates a debit amount for the purchase of the instant lottery ticket.

It should further be appreciated from the above that various embodiments of the present disclosure provide a point-of-sale (POS) data interceptor communicatively and operably connectable to a POS system comprising a POS system scanner that comprises a POS scanner housing and a POS system terminal that comprises a POS terminal housing. The POS data interceptor comprises: (1) an interceptor housing that is separate from the POS scanner housing and the POS terminal housing; (2) an interceptor scanner connector supported by the interceptor housing and communicatively connectable to an interceptor scanner comprising an interceptor scanner housing that is separate from the POS scanner housing; (3) a terminal connector supported by the interceptor housing and communicatively connectable to the POS system terminal such that the POS data interceptor is connected to the POS system terminal in addition to the POS system scanner; (4) a data transmitter supported by the interceptor housing; (5) a data receiver supported by the interceptor housing; (6) a processor supported by the interceptor housing and communicatively connected to the interceptor scanner connector, the terminal connector, the data transmitter, and the data receiver; and (7) a memory device supported by the interceptor housing. The memory device stores a plurality of instructions that when executed by the processor, cause the POS data interceptor to: monitor all scan data received from the interceptor scanner based on all scans by the interceptor scanner; responsive to receiving scan data that comprises lottery ticket related data that is related to a purchase of a lottery ticket: generate and send a lottery ticket purchase request for the purchase of the lottery ticket based on the lottery ticket related data to a lottery central system, receive from the lottery central system a lottery ticket purchase response comprising a product identifier for the lottery ticket and a value identifier for the lottery ticket that are based on the lottery ticket purchase request, and determine and cause transmittal of a product code for the purchase of the lottery ticket to the POS system terminal based on the product identifier; and responsive to receiving scan data from the interceptor scanner that does not comprise any lottery ticket related data, reject said scan data. In various such embodiments, the product identifier is stored by the lottery central system for lottery ticket purchases specific to the POS system, the product identifier comprises a retailer assigned product lookup code, the product code comprises a universal product code, the lottery ticket purchase response comprises a value identifier for the lottery ticket that is based on the lottery ticket purchase request, and the universal product code indicates a purchase value for the purchase of the lottery ticket based on the value identifier. In various such embodiments, the product identifier comprises a universal product code that indicates a purchase value for the purchase of the lottery ticket. In various such embodiments, the lottery ticket comprises a draw lottery ticket, the lottery ticket purchase request comprises a draw wager request for the purchase of the draw lottery ticket, the lottery ticket purchase response comprises a value identifier for the draw lottery ticket that is based on the lottery ticket purchase request, the product code indicates a purchase value for the purchase of the draw lottery ticket based on the value identifier, and the value identifier indicates a debit amount for the purchase of the draw lottery ticket. In various such embodiments, the scan data is based on a scan of a digital play slip displayed by a player electronic device, the digital play slip comprises a QR code that indicates bet details for the purchase of the draw lottery ticket, the draw wager request comprises the bet details, and the product identifier and the value identifier are based on the bet details for the purchase of the draw lottery ticket. In various such embodiments, the lottery ticket comprises an instant lottery ticket, the lottery ticket purchase request comprises an activation request for the purchase of the instant lottery ticket, the lottery ticket purchase response comprises a value identifier for the instant lottery ticket that is based on the lottery ticket purchase request, the product code indicates a purchase value for the purchase of the instant lottery ticket based on the value identifier, and the value identifier indicates a debit amount for the purchase of the instant lottery ticket.

It should further be appreciated from the above that various embodiments of the present disclosure provide a point-of-sale (POS) data interceptor communicatively and operably connectable to a POS system comprising a POS system scanner that comprises a POS scanner housing and a POS system terminal that comprises a POS terminal housing. The POS data interceptor comprises: (1) an interceptor housing that is separate from the POS scanner housing and the POS terminal housing; (2) a POS scanner connector supported by the interceptor housing and communicatively connectable to the POS system scanner such that the POS data interceptor is connected to the POS system scanner in place of the POS system terminal; (3) a terminal connector supported by the interceptor housing and communicatively connectable to the POS system terminal such that the POS data interceptor is connected to the POS system terminal in place of the POS system scanner; (4) a data transmitter supported by the interceptor housing; (5) a data receiver supported by the interceptor housing; (6) a processor supported by the interceptor housing and communicatively connected to the POS scanner connector, the terminal connector, the data transmitter, and the data receiver; and (7) a memory device supported by the interceptor housing. The memory device stores a plurality of instructions that when executed by the processor, cause the POS data interceptor to: monitor all scan data received from the POS system scanner based on all scans by the POS system scanner; responsive to receiving scan data that comprises lottery ticket related data that is related to a redemption of a lottery ticket: generate and send a lottery ticket validation request for the redemption of the lottery ticket based on the lottery ticket related data to a lottery central system, receive from the lottery central system a lottery ticket validation response comprising a product identifier for the lottery ticket and a value identifier for the lottery ticket that are based on the lottery ticket validation request, and determine and cause transmittal of a product code for the redemption of the lottery ticket to the POS system terminal based on the product identifier; and responsive to receiving scan data from the POS system scanner that does not comprise any lottery ticket related data, cause transmittal of said scan data without modification to the POS system terminal.

In various such embodiments, the product identifier is stored by the lottery central system for lottery ticket redemptions specific to the POS system, the product identifier comprises a retailer assigned product lookup code, the product code comprises a universal product code, and the universal product code indicates a redemption value for the redemption of the lottery ticket based on the value identifier. In various such embodiments, the lottery ticket comprises a winning draw lottery ticket, the lottery ticket related information comprises a ticket identifier that uniquely identifies the winning draw lottery ticket, and the value identifier indicates a credit amount for the redemption of the winning draw lottery ticket. In various such embodiments, the lottery ticket comprises a winning instant lottery ticket, the lottery ticket related data comprises a revealed validation code for the winning instant lottery ticket, and the value identifier indicates a credit amount for the redemption of the winning instant lottery ticket. In various such embodiments, the lottery ticket comprises a winning lottery ticket, the product identifier comprises the product code, the product code comprises a universal product code, and the lottery ticket validation response causes the POS data interceptor to print a validation instruction receipt comprising a printed barcode for the universal product code and a redemption value for the redemption of the lottery ticket based on the value identifier.

It should further be appreciated from the above that various embodiments of the present disclosure provide a point-of-sale (POS) data interceptor communicatively and operably connectable to a POS system comprising a POS system scanner that comprises a POS scanner housing and a POS system terminal that comprises a POS terminal housing, the POS data interceptor comprising: (1) an interceptor housing that is separate from the POS scanner housing and the POS terminal housing; (2) an interceptor scanner connector supported by the interceptor housing and communicatively connectable to an interceptor scanner comprising an interceptor scanner housing that is separate from the POS scanner housing; (3) a terminal connector supported by the interceptor housing and communicatively connectable to the POS system terminal such that the POS data interceptor is connected to the POS system terminal in addition to the POS system scanner; (4) a data transmitter supported by the interceptor housing; (5) a data receiver supported by the interceptor housing; (6) a processor supported by the interceptor housing and communicatively connected to the interceptor scanner connector, the terminal connector, the data transmitter, and the data receiver; and (7) a memory device supported by the interceptor housing. The memory device stores a plurality of instructions that when executed by the processor, cause the POS data interceptor to: monitor all scan data received from the interceptor scanner based on all scans by the interceptor scanner; responsive to receiving scan data that comprises lottery ticket related data that is related to a redemption of a lottery ticket: generate and send a lottery ticket validation request for the redemption of the lottery ticket based on the lottery ticket related data to a lottery central system, receive from the lottery central system a lottery ticket validation response comprising a product identifier for the lottery ticket and a value identifier for the lottery ticket that are based on the lottery ticket validation request, and determine and cause transmittal of a product code for the redemption of the lottery ticket to the POS system terminal based on the product identifier; and responsive to receiving scan data from the interceptor scanner that does not comprise any lottery ticket related data, reject said scan data. In various such embodiments, the product identifier is stored by the lottery central system for lottery ticket redemptions specific to the POS system, the product identifier comprises a retailer assigned product lookup code, the product code comprises a universal product code, and the universal product code indicates a redemption value for the redemption of the lottery ticket based on the value identifier. In various such embodiments, the lottery ticket comprises a winning draw lottery ticket, the lottery ticket related information comprises a ticket identifier that uniquely identifies the winning draw lottery ticket, and the value identifier indicates a credit amount for the redemption of the winning draw lottery ticket. In various such embodiments, the lottery ticket comprises a winning instant lottery ticket, the lottery ticket related data comprises a revealed validation code for the winning instant lottery ticket, and the value identifier indicates a credit amount for the redemption of the winning instant lottery ticket. In various such embodiments, the lottery ticket comprises a winning lottery ticket, the product identifier comprises the product code, the product code comprises a universal product code, and the lottery ticket validation response causes the POS data interceptor to print a validation instruction receipt comprising a printed barcode for the universal product code and a redemption value for the redemption of the lottery ticket based on the value identifier.

### Advantages of Interceptor

These various example embodiments of the present disclosure provide a series of advantages that enable lottery tickets to be purchased and redeemed via POS systems. The advantages include but are not limited to the following advantages: (a) providing a relatively low cost and inobtrusive device (the interceptor) that can be employed in each checkout lane in a wholesaler facility, a retailer facility, or other facility that enables the POS system therein to be used for the activation, purchase, validation, and/or redemption of lottery tickets; (b) providing a dedicated lottery printer at each POS system terminal for printing certain lottery tickets; (c) providing easy installation of such devices; (d) not requiring substantial changes to how operators use such devices or collect payments from customers; (e) providing such devices with limited required additional training by operators in such facilities to use such devices; (f) maintaining security needs for lottery systems and/or the retailer's own network(s); (g) providing interceptors that can connect to the lottery systems in real time using an operator's network, a dedicated network, or other suitable network; (h) providing for purchase of lottery tickets that are recorded on the POS systems with pre-defined UPC codes; (i) enabling lotteries and/or retailers to manage UPC code tables on POS lottery ticket data interceptors from remote locations; (j) generating POS payment receipts that function as payment confirmations for lottery purchases; (k) providing lottery instant ticket pack receipts in certain embodiments); (l) providing central lottery system setup to support instant lottery ticket activation on a pack basis or a ticket by ticket basis (if needed); (m) enabling a lottery system operator to set a variable priced wager for purchases of certain lottery tickets; (n) enabling a lottery system operator to set variable purchase prices for certain lottery tickets based on optional features and/or lottery ticket promotions associated with the lottery tickets; (o) enabling a lottery system operator to set variable purchase prices for certain lottery tickets based on a retailer facility at which a purchase was made; (p) enabling a lottery system operator to set variable redemption values for certain lottery tickets on validations; (q) enabling detailed tracking for purchases and/or redemptions of lottery tickets that are specific to a particular POS system for a retailer's facility; and/or (r) enabling different retailers to select different product codes for purchases and/or redemptions of otherwise identical lottery tickets at that retailer's facilities.

Various changes and modifications to the present embodiments described herein will be apparent to those skilled in the art. Such changes and modifications can be made without departing from the spirit and scope of the present subject matter and without diminishing its intended technical scope. It is therefore intended that such changes and modifications be covered by the appended claims.

1. A point-of-sale (POS) data interceptor communicatively and operably connectable to a POS system comprising a POS system scanner that comprises a POS scanner housing and a POS system terminal that comprises a POS terminal housing, the POS data interceptor comprising:
an interceptor housing that is separate from the POS scanner housing and the POS terminal housing;
a POS scanner connector supported by the interceptor housing and communicatively connectable to the POS system scanner such that the POS data interceptor is connected to the POS system scanner in place of the POS system terminal;
a terminal connector supported by the interceptor housing and communicatively connectable to the POS system terminal such that the POS data interceptor is connected to the POS system terminal in place of the POS system scanner;
a data transmitter supported by the interceptor housing;
a data receiver supported by the interceptor housing;
a processor supported by the interceptor housing and communicatively connected to the POS scanner connector, the terminal connector, the data transmitter, and the data receiver; and
a memory device supported by the interceptor housing;
wherein the memory device stores a plurality of instructions that when executed by the processor, cause the POS data interceptor to:
monitor all scan data received from the POS system scanner based on all scans by the POS system scanner;
responsive to receiving scan data that comprises lottery ticket related data that is related to a purchase of a lottery ticket:
generate and send a lottery ticket purchase request for the purchase of the lottery ticket based on the lottery ticket related data to a lottery central system,
receive from the lottery central system a lottery ticket purchase response comprising a product identifier for the lottery ticket based on the lottery ticket purchase request, and
determine and cause transmittal of a product code for the purchase of the lottery ticket to the POS system terminal based on the product identifier; and
responsive to receiving scan data from the POS system scanner that does not comprise any lottery ticket related data, cause transmittal of said scan data without modification to the POS system terminal.

2. The POS data interceptor of claim 1, wherein the product identifier is stored by the lottery central system for lottery ticket purchases specific to the POS system, the product identifier comprises a retailer assigned product lookup code, the product code comprises a universal product code, the lottery ticket purchase response comprises a value identifier for the lottery ticket that is based on the lottery ticket purchase request, and the universal product code indicates a purchase value for the purchase of the lottery ticket based on the value identifier.

3. The POS data interceptor of claim 1, wherein the product identifier comprises a universal product code that indicates a purchase value for the purchase of the lottery ticket.

4. The POS data interceptor of claim 1, wherein the lottery ticket comprises a draw lottery ticket, the lottery ticket purchase request comprises a draw wager request for the purchase of the draw lottery ticket, the lottery ticket purchase response comprises a value identifier for the draw lottery ticket that is based on the lottery ticket purchase request, the product code indicates a purchase value for the purchase of the draw lottery ticket based on the value identifier, and the value identifier indicates a debit amount for the purchase of the draw lottery ticket.

5. The POS data interceptor of claim 4, wherein the scan data is based on a scan of a digital play slip displayed by a player electronic device, the digital play slip comprises a QR code that indicates bet details for the purchase of the draw lottery ticket, the draw wager request comprises the bet details, and the product identifier and the value identifier are based on the bet details for the purchase of the draw lottery ticket.

6. The POS data interceptor of claim 1, wherein the lottery ticket comprises an instant lottery ticket, the lottery ticket purchase request comprises an activation request for the purchase of the instant lottery ticket, the lottery ticket purchase response comprises a value identifier for the instant lottery ticket that is based on the lottery ticket purchase request, the product code indicates a purchase value for the purchase of the instant lottery ticket based on the value identifier, and the value identifier indicates a debit amount for the purchase of the instant lottery ticket.

7. A point-of-sale (POS) data interceptor communicatively and operably connectable to a POS system comprising a POS system scanner that comprises a POS scanner housing and a POS system terminal that comprises a POS terminal housing, the POS data interceptor comprising:
an interceptor housing that is separate from the POS scanner housing and the POS terminal housing;
an interceptor scanner connector supported by the interceptor housing and communicatively connectable to an interceptor scanner comprising an interceptor scanner housing that is separate from the POS scanner housing;
a terminal connector supported by the interceptor housing and communicatively connectable to the POS system terminal such that the POS data interceptor is connected to the POS system terminal in addition to the POS system scanner;
a data transmitter supported by the interceptor housing;
a data receiver supported by the interceptor housing;
a processor supported by the interceptor housing and communicatively connected to the interceptor scanner connector, the terminal connector, the data transmitter, and the data receiver; and
a memory device supported by the interceptor housing;
wherein the memory device stores a plurality of instructions that when executed by the processor, cause the POS data interceptor to:
monitor all scan data received from the interceptor scanner based on all scans by the interceptor scanner;
responsive to receiving scan data that comprises lottery ticket related data that is related to a purchase of a lottery ticket:
generate and send a lottery ticket purchase request for the purchase of the lottery ticket based on the lottery ticket related data to a lottery central system,
receive from the lottery central system a lottery ticket purchase response comprising a product identifier for the lottery ticket and a value identifier for the lottery ticket that are based on the lottery ticket purchase request, and
determine and cause transmittal of a product code for the purchase of the lottery ticket to the POS system terminal based on the product identifier; and
responsive to receiving scan data from the interceptor scanner that does not comprise any lottery ticket related data, reject said scan data.

8. The POS data interceptor of claim 7, wherein the product identifier is stored by the lottery central system for lottery ticket purchases specific to the POS system, the product identifier comprises a retailer assigned product lookup code, the product code comprises a universal product code, the lottery ticket purchase response comprises a value identifier for the lottery ticket that is based on the lottery ticket purchase request, and the universal product code indicates a purchase value for the purchase of the lottery ticket based on the value identifier.

9. The POS data interceptor of claim 7, wherein the product identifier comprises a universal product code that indicates a purchase value for the purchase of the lottery ticket.

10. The POS data interceptor of claim 7, wherein the lottery ticket comprises a draw lottery ticket, the lottery ticket purchase request comprises a draw wager request for the purchase of the draw lottery ticket, the lottery ticket purchase response comprises a value identifier for the draw lottery ticket that is based on the lottery ticket purchase request, the product code indicates a purchase value for the purchase of the draw lottery ticket based on the value identifier, and the value identifier indicates a debit amount for the purchase of the draw lottery ticket.

11. The POS data interceptor of claim 10, wherein the scan data is based on a scan of a digital play slip displayed by a player electronic device, the digital play slip comprises a QR code that indicates bet details for the purchase of the draw lottery ticket, the draw wager request comprises the bet details, and the product identifier and the value identifier are based on the bet details for the purchase of the draw lottery ticket.

12. The POS data interceptor of claim 7, wherein the lottery ticket comprises an instant lottery ticket, the lottery ticket purchase request comprises an activation request for the purchase of the instant lottery ticket, the lottery ticket purchase response comprises a value identifier for the instant lottery ticket that is based on the lottery ticket purchase request, the product code indicates a purchase value for the purchase of the instant lottery ticket based on the value identifier, and the value identifier indicates a debit amount for the purchase of the instant lottery ticket.

13. A point-of-sale (POS) data interceptor communicatively and operably connectable to a POS system comprising a POS system scanner that comprises a POS scanner housing and a POS system terminal that comprises a POS terminal housing, the POS data interceptor comprising:
an interceptor housing that is separate from the POS scanner housing and the POS terminal housing;
a POS scanner connector supported by the interceptor housing and communicatively connectable to the POS system scanner such that the POS data interceptor is connected to the POS system scanner in place of the POS system terminal;
a terminal connector supported by the interceptor housing and communicatively connectable to the POS system terminal such that the POS data interceptor is connected to the POS system terminal in place of the POS system scanner;
a data transmitter supported by the interceptor housing;
a data receiver supported by the interceptor housing;
a processor supported by the interceptor housing and communicatively connected to the POS scanner connector, the terminal connector, the data transmitter, and the data receiver; and
a memory device supported by the interceptor housing;
wherein the memory device stores a plurality of instructions that when executed by the processor, cause the POS data interceptor to:
monitor all scan data received from the POS system scanner based on all scans by the POS system scanner;
responsive to receiving scan data that comprises lottery ticket related data that is related to a redemption of a lottery ticket:
generate and send a lottery ticket validation request for the redemption of the lottery ticket based on the lottery ticket related data to a lottery central system,
receive from the lottery central system a lottery ticket validation response comprising a product identifier for the lottery ticket and a value identifier for the lottery ticket that are based on the lottery ticket validation request, and
determine and cause transmittal of a product code for the redemption of the lottery ticket to the POS system terminal based on the product identifier; and
responsive to receiving scan data from the POS system scanner that does not comprise any lottery ticket related data, cause transmittal of said scan data without modification to the POS system terminal.

14. The POS data interceptor of claim 13, wherein the product identifier is stored by the lottery central system for lottery ticket redemptions specific to the POS system, the product identifier comprises a retailer assigned product lookup code, the product code comprises a universal product code, and the universal product code indicates a redemption value for the redemption of the lottery ticket based on the value identifier.

15. The POS data interceptor of claim 13, wherein the lottery ticket comprises a winning draw lottery ticket, the lottery ticket related information comprises a ticket identifier that uniquely identifies the winning draw lottery ticket, and the value identifier indicates a credit amount for the redemption of the winning draw lottery ticket.

16. The POS data interceptor of claim 13, wherein the lottery ticket comprises a winning instant lottery ticket, the lottery ticket related data comprises a revealed validation code for the winning instant lottery ticket, and the value identifier indicates a credit amount for the redemption of the winning instant lottery ticket.

17. The POS data interceptor of claim 13, wherein the lottery ticket comprises a winning lottery ticket, the product identifier comprises the product code, the product code comprises a universal product code, and the lottery ticket validation response causes the POS data interceptor to print a validation instruction receipt comprising a printed barcode for the universal product code and a redemption value for the redemption of the lottery ticket based on the value identifier.

18. A point-of-sale (POS) data interceptor communicatively and operably connectable to a POS system comprising a POS system scanner that comprises a POS scanner housing and a POS system terminal that comprises a POS terminal housing, the POS data interceptor comprising:
an interceptor housing that is separate from the POS scanner housing and the POS terminal housing;
an interceptor scanner connector supported by the interceptor housing and communicatively connectable to an interceptor scanner comprising an interceptor scanner housing that is separate from the POS scanner housing;
a terminal connector supported by the interceptor housing and communicatively connectable to the POS system terminal such that the POS data interceptor is connected to the POS system terminal in addition to the POS system scanner;
a data transmitter supported by the interceptor housing;
a data receiver supported by the interceptor housing;
a processor supported by the interceptor housing and communicatively connected to the interceptor scanner connector, the terminal connector, the data transmitter, and the data receiver; and
a memory device supported by the interceptor housing;
wherein the memory device stores a plurality of instructions that when executed by the processor, cause the POS data interceptor to:
monitor all scan data received from the interceptor scanner based on all scans by the interceptor scanner;
responsive to receiving scan data that comprises lottery ticket related data that is related to a redemption of a lottery ticket:
generate and send a lottery ticket validation request for the redemption of the lottery ticket based on the lottery ticket related data to a lottery central system,
receive from the lottery central system a lottery ticket validation response comprising a product identifier for the lottery ticket and a value identifier for the lottery ticket that are based on the lottery ticket validation request, and
determine and cause transmittal of a product code for the redemption of the lottery ticket to the POS system terminal based on the product identifier; and
responsive to receiving scan data from the interceptor scanner that does not comprise any lottery ticket related data, reject said scan data.

19. The POS data interceptor of claim 18, wherein the product identifier is stored by the lottery central system for lottery ticket redemptions specific to the POS system, the product identifier comprises a retailer assigned product lookup code, the product code comprises a universal product code, and the universal product code indicates a redemption value for the redemption of the lottery ticket based on the value identifier.

20. The POS data interceptor of claim 18, wherein the lottery ticket comprises a winning draw lottery ticket, the lottery ticket related information comprises a ticket identifier that uniquely identifies the winning draw lottery ticket, and the value identifier indicates a credit amount for the redemption of the winning draw lottery ticket.

21. The POS data interceptor of claim 18, wherein the lottery ticket comprises a winning instant lottery ticket, the lottery ticket related data comprises a revealed validation code for the winning instant lottery ticket, and the value identifier indicates a credit amount for the redemption of the winning instant lottery ticket.

22. The POS data interceptor of claim 18, wherein the lottery ticket comprises a winning lottery ticket, the product identifier comprises the product code, the product code comprises a universal product code, and the lottery ticket validation response causes the POS data interceptor to print a validation instruction receipt comprising a printed barcode for the universal product code and a redemption value for the redemption of the lottery ticket based on the value identifier.
